(19) United States
(12) Patent Application Publication
(10) Pub. No.: US 2014/0012414 A1
(43) Pub. Date: Jan. 9, 2014

(54) SYSTEM AND METHOD OF TELEMETRY APPLIED TO VENDING MACHINES

(71) Applicants: Álvaro Osnaya Pérez, Mexico (MX); José Luis Pérez Magaña, México D.F (MX); Jorge Corredor Villarreal, Edo. de Méx. (MX)

(72) Inventors: Álvaro Osnaya Pérez, Mexico (MX); José Luis Pérez Magaña, México D.F (MX); Jorge Corredor Villarreal, Edo. de Méx. (MX)

(21) Appl. No.: 13/784,521

(22) Filed: Mar. 4, 2013

(30) Foreign Application Priority Data
Mar. 5, 2012 (MX) MX/E/2012/018552

(51) Int. Cl. G07F 11/00

(52) U.S. Cl. CPC G07F 11/002
USPC 700/241

(57) ABSTRACT

System and method of telemetry applied to vending machines. This system possesses telemetry modules (AE2.0) specially designed to be installed in each of the vending machines that make up the system. These modules possess 8 bit microcontrollers with RISC architecture (Reduced Instruction Set Computer) that contain an embedded application (firmware) that controls all of its functions. On the other hand, the system involves applications and web services that are located in servers and/or some computer system, and have as their main functions the management and operation of the entire system. The entire system is composed of vending machines, telemetry modules (one per machine), and computer management and operation systems.

### CROSS REFERENCE TO RELATED APPLICATIONS

The present application claims the benefit under 35 U.S.C. §119(a)-(d) of Foreign Application Serial No. MX/E/2012/018552 filed Mar. 5, 2012 and entitled “Sistema y Método de Telemetría Aplicado a Máquinas Expendedoras,” which is incorporated herein by reference for all purposes.

### TECHNICAL FIELD

This invention is generally related with the field of telemetry. Particularly, this invention consists in the implementation of a system composed of vending machines, web servers, electronic devices, business protocols and algorithms that interact amongst one another.

### BACKGROUND

In the technical status, there exist some documents that show (at first glance) systems similar to the one described in this patent, but the one described herein possesses clear advantages and technical and technological differences. Such is the case of the patent application: MX/A/2008/013379, entitled: NEW ELECTRONIC DEVICE FOR THE SALE OF INTANGIBLE PRODUCTS IN VENDING MACHINES. Or else, application number MX/a/2008/013378, entitled: NEW PLATFORM FOR REMOTE COMMERCIAL TRANSACTIONS, THROUGH VENDING MACHINES OF PRODUCTS. Notwithstanding the above, the systems of technical status do not describe the necessary protocols and algorithms necessary to perform the functions that supposedly are needed, nor do they perform a series of steps that together with the system render this invention as a result.

### GLOSSARY

### Telemetry

Telemetry is a technology that allows for the remote measurement of physical magnitudes and the latter sending of information towards the system operator. The word telemetry comes from the Greek words tele, which means: from a distance, and the word metron, which means: measurement.

The sending of information towards the operation in a telemetry system is typically made through wireless communication, although it may also be made through other means (telephone, computer networks, fiber optic links, etcetera). The telemetry systems receive instructions and necessary data to operate from the Command Center.

Telemetry traditionally is used in large systems, such as space ships, chemical plants, supply networks for electricity, supply networks for gas, among other public utilities companies, because it facilitates the automatic monitoring and the registry of measurements, as well as the sending of alerts or alarms to the control center, with the purpose of safe and efficient functioning.

A very important application of telemetry is the drilling of oil wells. It is used for measurements with sailing tools. However, the use given in this patent is that of monitoring the variables within a system composed of vending machines (VM, Vending Machines) (individual or in groups), in such a way that it is possible to obtain information from them, such as: sales, inventory, closings, alarms, prices, etc.

The application of telemetry in this field, allows for (among other things) the planning of routes and visits to vending machines, as to not spend material and human resources unnecessarily, and also to quickly and efficiently pay attention to the supplying of machines that require so, significantly elevating their commercial efficiency.

To use telemetry in vending machines, it is precise to use a means of wireless or wired communication, which further extends business possibilities by allowing for the annexation of other technologies for the sales of services, for instance: the sale of Electronic Pre-paid air time, or the payment of services.

### SUMMARY

The main objective of this invention is to considerably facilitate the logistics tasks of administration and operation of vending machines systems, and hence reduce costs and improve commercial performance.

A second objective of this invention is to incorporate new business opportunities to the companies working in the marketing of products, through vending machines, such as the sale of Electronic Pre-paid air time (TAE), payment of services, etc.

A third objective of this invention is to enhance the functions possessed by vending machines through the incorporation of new technologies and versatility in the type and form of connection among them and the new devices existing in the market. Some examples of these are Bluetooth connectivity, NFC (Nearfieldcommunication) payment systems, WiFi, etc.

A fourth objective of this invention is that of providing a system and method that allow for local communication amongst the devices that make up the system.

A fifth objective of this invention is that of providing a telemetry system that is made up by 3 basic parts: the vending machines, the telemetry modules, and the web applications and services installed in remote computers. Other additional advantages will be evident from the dependent claims attached.

### BRIEF DESCRIPTION OF THE DRAWINGS

For a more complete understanding of this disclosure and its features, reference is now made to the following description, taken in conjunction with the accompanying drawings, in which:

FIG. 1 is a block diagram of a telemetry system incorporating a telemetry module in accordance with one embodiment of the present disclosure;

FIG. 2 is a block diagram of the telemetry module of FIG. 1 in accordance with one embodiment of the present disclosure;

FIG. 3 is a somewhat simplified flow diagram illustrating a method of initialization of the telemetry module of FIG. 2 in accordance with one embodiment of the present disclosure;

FIG. 4 is a somewhat simplified flow diagram illustrating a method of operating the telemetry module of FIG. 2 in accordance with one embodiment of the present disclosure;

FIG. 5 is a somewhat simplified flow diagram illustrating a method of configuring certain parameters of the telemetry module of FIG. 2 in accordance with one embodiment of the present disclosure;

FIG. 6 is a somewhat simplified flow diagram illustrating a method of transmitting extracted telemetry data in accordance with one embodiment of the present disclosure;

FIG. 7 is a somewhat simplified flow diagram illustrating a method of requesting information from the telemetry module of FIG. 2 in accordance with one embodiment of the present disclosure;

FIG. 8 is a somewhat simplified flow diagram illustrating a first stage in a method of executing a payment in accordance with one embodiment of the present disclosure;

FIG. 9 is a somewhat simplified flow diagram illustrating a second stage in a method of executing a payment in accordance with one embodiment of the present disclosure;

FIG. 10 is a somewhat simplified flow diagram illustrating a third stage in a method of executing a payment in accordance with one embodiment of the present disclosure;

FIG. 11 is a somewhat simplified flow diagram illustrating a fourth stage in a method of executing a payment in accordance with one embodiment of the present disclosure;

FIG. 12 is a block diagram of supply circuits of the telemetry module of FIG. 2 in accordance with one embodiment of the present disclosure;

FIGS. 13A-D each illustrate part of a diagram that together depicts a block diagram of a circuit control and ports of the telemetry module of FIG. 2 in accordance with one embodiment of the present disclosure;

FIG. 14 is a block diagram of a matrix of the telemetry module of FIG. 2 in accordance with one embodiment of the present disclosure;

FIG. 15 is a block diagram of a modem circuit of the telemetry module of FIG. 2 in accordance with one embodiment of the present disclosure;

FIG. 16 is a block diagram of a voice circuit of the telemetry module of FIG. 2 in accordance with one embodiment of the present disclosure;

FIG. 17 is a block diagram of an LCD circuit of the telemetry module of FIG. 2 in accordance with one embodiment of the present disclosure;

FIG. 18 is a block diagram of an MDB circuit of the telemetry module of FIG. 2 in accordance with one embodiment of the present disclosure; and

FIG. 19 is a block diagram of a radio frequency cards circuit of the telemetry module of FIG. 2 in accordance with one embodiment of the present disclosure.

### DETAILED DESCRIPTION

This system uses standard protocols of communication with vending machines: MDB and DEX. The MDB communication protocol is a bus type protocol that allows for the communication among a vending machine's control card and its peripheral devices, such as: coin slots, bill slots, non-cash payment devices (cashless), etc. It is a public domain protocol voluntarily developed by the “National Automatic Merchandising Association” (NAMA) to be used broadly by vending machines of any type of products. The minimum required version of this protocol for recharging Electronic Pre-paid air time (hereinafter TAE) is version 2.0.

The DEX communication protocol is a serial type public domain protocol with “one on one” communication, developed voluntarily by the “European Vending Association” (EVA) in cooperation with NAMA. It is in charge of sending data from the vending machine's control card to an external device, a portable computer (handheld) for example, or any other device that possesses a series RS-232 port to establish communication. The types of data transmitted through this means are sales, prices, inventory, alarms, etc. For the physical connection with the vending machine's control card, an audio stereo connector is used in America, whereas in Europe an infrared communication port is more commonly used through a protocol developed by the “Infrared Data Association” (IrDA).

To this moment, the protocols described allow for local communication among the devices that make up the vending machine. However, to achieve remote communication, the use of another protocol called: “Transmission Control Protocol” (TCP) is required. This protocol is jointly used with a “General Packet Radio Service” (GPRS) that is an extension of a “Global System for Mobile Communications” (GSM).

The protocols described in the paragraph above may jointly work to establish a connection by means of an “Access Point Name” (APN), and in such a way enable an Internet connection to link the vending machines with a system that has been developed to manage and remotely operate them (its generic name in English is: Backoffice).

For the connection among vending machines and the aforementioned system, a telemetry module was also developed (baptized as AE2.0) that, among other components, possesses a wireless modem. The letters AE2.0 are in reference to a telemetry module with Statistical Applications, version 2.0.

Such module is connected to the vending machines through the MDB and DEX protocols previously explained and to the management and operation system (Backoffice) through an APN and other aforementioned protocols by using its modem. Both the modem and the system mentioned are described below.

The AE2.0 is a telemetry module that possesses an internal medium or device of wireless communication (GPRS/EDGE or TD-SCDMA/HSDPA modem, or any recently developed wireless technology), which receives instructions through AT commands for its operation. This device is responsible for using the aforementioned protocols to achieve communication between the AE2.0 and its remote Backoffice. Its form of operation is briefly described in the following sentences.

When the modem is energized and started, it sends a non-solicited response command (RDY), which indicates it is on and its serial communication is operational. Afterwards, it validates if the SIM (Subscriber Identity Module) is inserted, and, if affirmative, sends another non-solicited response command (+CPIN: READY).

To establish a wireless connection, the modem uses three facts: the name of the APN, a user, and a password. Once the data has been validated by the web service, an IP address is assigned. At this time, the modem is now capable of being configured as “client” of a TCP server or as a “server” and establish a listening port to receive petitions from TCP remote clients. Once the communication between the modem and the network service has been satisfactorily established, it is possible to perform telemetry tasks, firmware updates, sale of pre-paid air time, etc.

The wireless modem additionally has a real time clock that is synchronized each time a new connection is established. If the vending machine is not connected to the network, it is not necessary to synchronize its clock, since there will be no management or transactional operation that requires it be used.

As seen in the paragraphs above, the modem that is part of the AE2.0 module is (along with other elements), the key piece that provides the wireless telemetric capabilities, which in turn facilitates and enhances the sale of intangible products, etc., while the MDB and DEX communication ports provide internal connectivity with the vending machine. However, to provide alternative forms of communication among the AE2.0 and its Backoffice, there is also the ability to implement Ethernet type connections, which serve as communication ports just like the modem, and that may be added to the system upon client's request.

Additionally, the AE2.0 module possesses a 16 button keypad and a liquid crystal (LCD) graphic screen that give the user or technician a form of operating the AE2.0's functions and visualizing its results.

### System Elements

The telemetry system is composed of 3 basic parts: 1. The vending machines, 2. The telemetry modules, and 3. The web applications and services installed in remote computers (hereinafter Backoffice). Of these 3 components, the latter 2 are those that contain the innovations mentioned herein.

In the first place, there is telemetry module AE2.0, which contains an embedded application that is based on a Real Time Operational System (RTOS). Such operational system functions based on the execution of a series of tasks, which alternate sequentially in shifts and in predefined times. In doing so, the system allows a “multitask” kind of performance. Even though the tasks are not executed simultaneously with one another, their execution is so fast that it seems as if they do.

Nonetheless, it is also possible to disable one or more tasks with the objective of giving priority to those that have critical functions in a given moment. Once the critical functions have been executed, those tasks that were inhibited may be reactivated. Thanks to its operational system, the application is more versatile with what was previously described.

The application that is programmed in the microcontroller of the telemetry module has 5 basic tasks: 1. LED task, 2. Keypad Task, 3. DEX Task, 4. Server Task, and 5. Reader Machine Task. Each one of these tasks is described as follows:

1. LED Task: Controls the lights on some tasks and diagnostic systems, serves as a visual indicator upon turning on and off an LED a number of times or with a certain detectable frequency, enabling to see if the application is performing or if it is stopped for some reason. It also grants the technician or designer an idea of the frequency with which the application (hereinafter firmware) is being executed. This task remains enabled most of the time, except for in some special cases, such as when the DEX is extracted.

2. Keypad Task: it is in charge of making a “sweep” of the matrix comprised of 16 buttons in the keypad. This way, only 8 pins from the microcontroller are used, instead of using 16 in a direct manner. As soon as one key is pressed, it is recognized by the task and accordingly processed.

3. DEX Task: It allows for the communication between the AE2.0 and the vending machine's control card (hereinafter VMC, as in: Vending Machine Control), to extract the corresponding information with inventory and alarms (DEX). This information is stored in a FLASH memory, and is then formatted in accordance with a protocol particularly designed for this function, and is immediately sent through the modem (or equivalent communication device: Ethernet or WiFi) to an application server (that is a part of the Backoffice). The extraction of DEX data is made automatically pursuant to the time previously programmed in the AE2.0, however, it may also be made manually by directly accessing to its menu, or remotely from an application that consumes a web service (also part of the Backoffice). One more function of this task is the monitoring of the connection with the APN network approximately every 10 minutes. If the connection fails, a reconnection is attempted, and if this fails, it continues with a pre-programmed resetting of the modem, and should this also fail, a general resetting of the module is made that allows for system recovery.

4. Server Task: Most of the time, the telemetry module is configured in “server” mode, so that it may pay attention to requests from a device configured as “client”. One remote application that consumes a web service makes petitions for sales, inventories, alarms, prices, etc., to the AE2.0, which responds with the data requested. This same “client” may initiate a remote update of the firmware for the AE2.0.

5. Reading Machine Task: Is in charge of communicating the AE2.0 with the VMC of the Vending Machine through a protocol called MDB (previously described). It enables collections, TAE purchases, and payments with a system of prepaid electronic cards (Cashless). TAE purchases are possible as long as the VMC possesses at least version 2.0 of the MDB protocol.

Secondly, there is the server application (hereinafter ServerV), the web service (hereinafter WSTeleInter), and the web management and operation service (hereinafter VendVolution). All of the applications herein mentioned incorporate the Backoffice.

The ServerV is in charge of receiving all requests from the AE2.0 modules. It was previously mentioned that the AE2.0 behaves most of the time as a “server”, however, when it has to send information from the vending machine to the ServerV, it is previously configured as “client”. Once the ServerV has received the data from the AE2.0, it processes them and registers them in a database for their ensuing management and/or consultation.

The WSteleinter is a remote web service that allows for the execution of a cluster of different functions. These functions at the same time hold a cluster of sub-functions that give greater versatility to the system. The main functions are: 1. Inventory Search, 2. Alarm Search, 3. Closings Search, 4. Remote Updates of the AE2.0 modules, 5. Modem configuration, 6. Obtaining and modifying prices, 7. Obtaining and modifying maximums and minimums, and 8. Connection trials with the database. To consume this service, there is a friendly user interface called Vendvolution that allows for an agile use.

Vendvolution is a platform—a web application that runs on any Internet browser (Mozilla Firefox, Opera, Internet Explorer, Google Chrome, Safari, etc.). VendVolution is made up of a series of web listings and forms that have access to databases with the purpose of managing and operating the system. The management part is in charge of creating and/or editing the registries of vending machines, routes, clients, technicians, etc., while the operational part is in charge of consulting based on databases to present filtered lists and prepare reports on resupplying, technical visits, etc. It also has the function of consuming the services available from the WSteleinter.

Microcontroller (MCU)

The telemetry module is equipment that performs different tasks, using the telecommunications applied to the managing of vending machines. The main device that executes the firmware or main program of the telemetry module AE2.0, is a microcontroller (generally an 8 bit module is used, with RISC “Reduced Instructions Set Computing” architecture).

The microcontroller (MCU) is an electronic device that possesses a central processing unit (UCP) and different peripherals incorporated in a same capsule. Some of the internal elements that it possesses are: FLASH, RAM, and EEPROM memories, serial communication ports (in TTL levels), analog-digital converters, etc. Specifically, the most used model as control of the telemetry module has 256 Kbytes in Flash Memory (memory used to store the program), 8 Kbytes in SRAM memory (random access memory storage), 4 Kbytes in EEPROM (non-random access memory storage), BootLoader programmable section, 4 serial USART ports, 8 PWM channels, ADC with 8 channels, SPI (Serial Peripheral Interface) port, among other characteristics.

The capsule used is of TQFP type (Thin Quad Flat Pack) that has a superficial dismantle and 100 pins for this MCU model. The maximum frequency of operation is of 16 MHz, and since this type of MCUs executes one command per cycle, it allows for a performance of 16 MIPS (Millions of Commands per Second). However, the default frequency of performance is of 9.8304 MHz.

VMC Tasks

The task of communication between the telemetry module and the vending machine's electronic control card (VMC, Vending Machine Control) is executed through a protocol called DEX (previously explained) which is derived from the standard EVA. In most cases, the MCU is configured in master mode and the VMC in slave mode (although there are exceptions). Once communication is established, the MCU may request that the VMC deliver all the information it has gathered, while the VMC receives a series of packages until the transfer of data has been completed effectively.

Network Connection Tasks

Some of the main tasks that the MCU performs are sending and receiving information through Internet using a wireless modem (or equivalent device). The MCU configures the modem in two ways: (as a server or as a client, according to the task it is going to perform. The normal form of operating for the telemetry module is in server mode. Below is a description of the operation modes:

Configuration of the Modem in Client Mode

This operation is executed when the module has to send information to a server, the MCU communicates with the modem through a serial port (generally the USART2) at a velocity of 9600 bps (bits per second) sending commands and configuration information. The most important parameters of configuration are the Internet Protocol (IP Internet Protocol), the server's communication port, and its IP address. The data travels via GPRS, EDGE, TD-SCDMA/HSDPA, etc., under protocol TCP/IP.

Configuration of the Modem in Server Mode

This operation is executed when a remote client wishes to communicate with the telemetry module, requesting information, or managing it from a remote location. The MCU sends the following information to the modem: IP address, port, and name of identification (ID).

Keypad and Screen Tasks

The MCU has connected in its L port (PORTL) a keypad with a matrix of 4×4 and a liquid crystal screen (LCD), which is used to display text and/or graphics to interact with the user. There exist functions to display menus and options in the LCD, in a way that the user only has to select the option menu through the keypad. The MCU contains functions that assign a value in ASCII (American Standard Code for Information Interchange) code to each key.

Description of the Telemetry Module's Functioning

The first step is to verify if there is a petition for update of the application (BootLoader). If affirmative, the program jumps to a special memory address and executes the updating of the MCU's firmware function. Once this operation is concluded, the module is rebooted. The described function may be executed locally or from a portable device (generally a handheld), or remotely, using the Web Service: WSTeleInter, previously described.

The next step is the initialization of the module. In this process the following sections of the MCU's hardware are initialized: 1. Entry/exit I/Os Pins, 2. SPI, 3. USART's, 4. Functions, 5. Modem, 6. External memories, etc. After initialization, the module is connected to the APN and finally commutes to energy saving mode (Standby) waiting for the user to press the “Enter” key, or for a programmed interruption to occur, for example: the sending of an inventory or alarm

When the module is connected to the APN network and the user presses the “Enter” key, a message is displayed on the screen: TAE Purchase. This same screen displays 3 options, each one with a different amount for the user to select the amount of credit that it wishes to purchase for its cellular phone. When the user selects an amount, it will request that the user insert into the vending machine's payment devices the exact amount selected, after which it will request that the user input a cellular phone number and a confirmation of such number to complete purchase.

The operation tasks consist in sending sales, closings, inventory, and alarms to the server, selecting the options from the menu. In another option from the menu it displays information regarding the modem and module's parameters, such as signal levels, IP address, serial number, etc.

The configuration tasks are shown in the same way as those described beforehand. Among these are the configuration functions of the module and the GPRS modem, such as: IP address, Port, ID, serial number, etc.

Types of Connection and AE2.0 Module's Peripherals

Near Field Communication (NFC)

To provide greater functionality to the telemetry system, knowledge is required of the new technologies in this field and with such, quickly and efficiently execute their implementation. This is the case with Near Field Communication technology (NFC). This technology is used (among other things) to carry out monetary transactions through electronic means without physical contact.

It is a wireless communication technology through radiofrequency, of short range and high frequency that allows for exchange of data without physical contact between devices at least 10 cm apart. It is an extension of ISO 14443 standard (RFID, Radio Frequency Identification).

As in ISO 14443, the NFC devices communicate through induction into a magnetic field, where two spiral antennas are placed within their respective near fields. It works in the 13.56 MHz range, which requires no license for its use nor is subject to any restriction.

It supports two modes of functioning: 1. Active. Both devices generate their own electromagnetic fields that are used to transmit their data, 2. Passive. Only one device generates the electromagnetic field and the other takes advantage of the modulation charge to transfer data. The initiator of communication is in charge of generating the electromagnetic field.

The NFCIP-1 protocol may function at different speeds such as 106, 212, 424 or 848 Kbit/s. According to the environment in which it works, both parties may agree at what speed to work on and readjust the parameter at any moment of communication.

The form in which the described technology interacts with the telemetry module is through the use of one of the module's ports for the connection with an NFC reader. In this case, the payment device may be a proximity card (RFID, Radio Frequency Identification), or else, a cellular phone with NFC connection. Payment may be made using the RFID proximity card or the chip's credit.

The following case is described as an example: The user must make a request for a product or service to the vending machine and carry out payment using its payment device (RFID card or cellular phone) near the NFC reader device duly signaled on the machine. The NFC reader receives the necessary information from the RFID card and performs the electronic discharge of the corresponding credit.

Once payment is confirmed (either through RFIC or pone), the module tells the vending machine to render the previously requested product or service to the client. Finally, a command is sent to the printer so that it delivers a receipt (ticket) as proof of purchase.

Printing of Receipts (Tickets) with Printer

Nowadays, any formally established sales point for products and/or services has the obligation of printing a receipt (ticket) for each sale it makes. Such ticket serves as proof of payment for the purchase made by the consumer and may be used to make claims in case the product and/or service was not duly delivered. Occasionally, it also serves a control function for taxes.

For the reasons herein mentioned, it is essential that a ticket printer be connected to the AE2.0 module. The brand and/or model of the printer may vary according to availability and/or requirements of size, cost, functionality, etc.

A thermal printer obtains image through the warming up of heat sensitive paper. This is a system often used in points of sale, automatic teller machines, to print tickets or receipts, or to create labels.

Thermal printers only enable monochromatic printing in black color; however, with more recent models that use special paper, printing in red or blue color is also possible. On the other hand, costs per copy are very low, since nothing else is consumed but the paper. The speed of printing usually is between 100 and 206 mm/s. Such mms/s units refer to millimeters of rolled up paper that is printed per second.

It is very convenient to use a thermal printer to reduce system operation costs, although the system is not limited to using one type of particular printer.

The AE2.0 module tells the printer (through a serial port) that it may print a ticket, only in the case where the client has requested one and paid for a certain product and/or service. The information printed on the ticket is also registered by the system to keep a control of sales. If the machine were to temporarily run out of paper, the telemetry module informs the user of this prior to purchase.

The printer model that the module possesses, has a sensor that sends an alarm when it detects that the roll of paper is about to run out. This alarm is sent to the telemetry module, which retransmits this to the central control center so that it generated a report informing of this event to the personnel in charge of supplying inputs into the vending machines.

Magnetic Stripe Reader

To implement payment of products and/or services through credit card, debit cards, electronic cash holders, etc., the telemetry module possesses a magnetic stripe reader. This device sends the card's information to the telemetry module, which in turn sends the information from the network to the corresponding bank institution for its validation. Once the information is validated, confirmation is provided and the vending machine may proceed with sale.

A magnetic stripe (sometimes called magstripe as an abbreviation) is any dark stripe located on credit or debit cards, public transportation cards, or personal credentials, that is made up of ferromagnetic particles incrusted into a resin matrix (generally epoxy) that store a certain amount of information through a determined code that polarizes such particles. The magnetic stripe is recorded or read when it slides through a reading/writing machine, thanks to the phenomena of magnetic induction.

In standard identification card applications, such as those used for financial transactions, the information contained in the magnetic stripe is organized into different tracks. The format and structure of data in these tracks are regulated by international standards ISO7813 (for tracks 1 and 2) and ISO4909 (for track 3).

These cards are different from the new generation of intelligent cards that contain a chip with metallic contacts (SIM card), or contact-less cards that use a magnetic field or radiofrequency (RFID) for their reading from a certain distance.

However, the use of magnetic stripe cards is so extensive, that it will continue to form a part of systems for the sale of products and/or services as the one described for this patent during an indefinite period of time.

Bluetooth Connection

Provided that nowadays, most cellular phones have connection through the “Bluetooth” specification, it is a good tool as an extra connection with the telemetry module.

This type of connection enables the technicians in charge of the vending machine to connect through their cellular phones, without the need of using cables or any other mechanical means. This connection may be used for closings, firmware updates, etc.

Bluetooth is an industrial specification for Wireless Personal Area Networks (WPANs) that enables voice and data transmission between different devices through a radiofrequency link in the Industrial, Scientific, and Medical (ISM) range of 2.4 GHz. The main characteristics of this norm are: 1. Facilitating communication among mobile and fixed devices, 2. Eliminating cables and connectors among these, 3. Offer the possibility of creating small wireless networks and facilitating synchronization of data among personal equipment.

The devices that most often use this technology belong in the telecommunication and personal information sectors, such as PDA, mobile phones, portable computers, personal organizers, printers, or digital cameras.

Wireless Modem

The wireless Modem is a telecommunication device that is in charge of making an Internet connection via wireless GPRS (General Packet Radio Service), EDGE (Enhanced Data for Global Evolution), or third generation such as: 3G (TD-SCDMA/HSDPA), 3GPP LTE, etc. The communication interface between the modem and the microcontroller (MCU) is serial at TTL levels and may be configured from 9,600 to 115,200 bps. Through this communication the MCU sends AT commands to the modem so that the modem executes certain functions that are part of the module application.

Once the modem has been initialized, it will send a non-requested response command “RDY”, which will show the modem is on and serial communication has been correctly established. Promptly afterwards it detects the presence of a SIM (Subscriber Identity Module) card. If a SIM card is inserted into the corresponding socket, the modem will send a non-requested response command “+CPIN: READY”, which will indicate that a SIM card has been detected.

The protocol used in the application is the TCP/IP, in such a way that through AT commands, the MCU will send the necessary commands to the modem to establish wireless connection to the APN (Access Point Name). Once the name of the APN has been established, the user name and password, the next step is to setup the wireless connection with GPRS, EDGE, or 3G and at this time the modem acquires an IP provided by the network service.

The modem may connect as client towards a TCP server or establish a listening port to configure itself as a server and receive petitions from remote TCP clients. The velocity of data transfer will depend on the modem that the AE2.0 module has incorporated, which may be equipped with a GSM/GPRS modem or up until a third generation (3G) modem that foresees TD-SCDMA/HSDPA technology, or any technology in its reach.

WiFi Connection

The AE2.0 module provides the possibility of wireless connection through a local area WiFi network. In such a way, it may be connected as client or as server (using TCP/IP protocol) for the remote transfer of data. The WiFi connection has the capacity to substitute the modem for communication between the AE2.0 and its Backoffice.

This connection has the advantage of not depending on the cellular network provided by the cellular phone service provider (carrier), but instead it depends directly on a point of WiFi access located within the same facilities where the AE2.0 module is located, and this way it has the ability to establish a faster and broader connection based on the IEEE 802.11 standard. The data transfer rate of a WiFi connection may reach 54 Mbps, in other words, much faster than the one used by GPRS, EDGE, or even 3G (UMTS y HSDPA) technologies.

The AE2.0 Telemetry module must be physically within the radius of reach from the WiFi Access Point. At the time of connection, the module obtains an IP address with which it may be linked with remote web services and make data transfers such as: inventories, alarms, configurations, prices, etc. This data is previously obtained by the AE2.0 module of the vending machine through DEX and then sent to the corresponding Backoffice.

Ethernet Connection

The AE2.0 module also offers the additional possibility of connecting through a local area network (LAN) through an Ethernet port, which is integrated into the mother card of the AE2.0. The embedded Ethernet device may be linked to the network by default, or its configuration may be modified by authorized personnel. In such a way, the module obtains an IP address provided by the LAN and the module may communicate with ServerV as a TCP client or have server configuration as a listening port to receive requests from a remote client, or in this latter case, from a web service that integrates the Telemetry system Vendvolution.

Internet connection through Ethernet provides a very important advantage to the module, since it does not depend on the cellular network, rather on the LAN to which it is linked. This connection may be used if the vending machine is in closed areas within buildings or facilities where it is easy to wire.

Once the module has been connected via Ethernet, it is capable of performing its functions of sending inventories, alarms, prices, settings, etc., in a trustworthy and much faster manner, that when using an equivalent wireless modem.

Chip Cards (Smart Cards) Reader

Telemetry module AE2.0 has a reader for smart cards or chip cards (SIM Cards), which performs the following functions: 1. Identification of users for the purchase of the Vending Machine's products, 2. Reading of pre-paid credit balance in the smart card, and 3. Writing of new credit balance on the smart card. With these functions, it allows for the purchase of intangible products such as TAE purchases for cellular phones or payment of services.

1. User Identification for the Purchase of Vending Machine Products

The user may insert its smart card in the vending machine's reader; the AE2.0 module detects it and reads the information found in its chip. The module then requests the user with a password (previously provided to the administrative system Vendvolution). The information is sent through the network to the ServerV application through the modem (or alternate Internet connection device). In such a way, the system verifies the user's data in its own database.

The system validates if the user is registered and, according to its profile, allows or does not allow the purchase of products from the vending machine, making use of the module to select the product. The vending machine receives the order for delivering a product and the operation is registered in the central system through the confirmation sent to ServerV.

If the user does not possess a smart card, there is an alternate form for the system to identify. This mode of functioning requires the use of the keypad and screen. The user must enter its name and password to be validated by the system and obtain the requested products from the vending machine. This type of functioning may be required, for instance, within an industrial plant or an office building. The availability of type and quantity of products is defined by the system manager.

2. Reading of Pre-Paid Credit Balance in the Smart Card

This function has the objective of providing the user with the possibility of having a prepaid card for the purchase of products from the vending machine. Such card shall be provided with an initial balance equal to the card's value and in such a way, the user may purchase products from the vending machine.

The first step will be inserting the smart card in the Reading slot; the module reads the available credit and displays it in both the vending machine screen and in the module. The second step is selecting a product from the vending machine that is of equal or lesser price in comparison to the credit balance in the card, then the vending machine delivers the product and the AE2.0 module subtracts the corresponding credit. If a product is selected that is of a price greater than the credit available, the vending machine will display that there is not sufficient credit to complete purchase.

3. Writing of New Credit Balance in the Smart Card.

When the user wishes to increase its credit in the smart card, it may do so through the reader/writer device for SIM Cards on the vending machine. The first step is to insert the smart card in the corresponding slot. The second step is to insert the money, either in coins or bills, depending on the vending machine's slots. When inputting a coin or a bill, the collecting device transfers the amount to the AE2.0 module for the acceptance or declining of the increase in credit balance towards the smart card. Finally, the new balance appears on screen and the card may be removed.

Once the recharge has been made, the card may be used as an electronic money holder to acquire any product from any machine in the network, or for the payment of a service.

Purchase of Intangible Products: Electronic Pre-Paid Air Time (TAE) Purchases

The AE2.0 telemetry module has the possibility of selling intangible products such as TAE purchases. To carry out the purchase of an intangible product, the button shown on screen must be pressed (green button in the lower right corner of the module). The ensuing step is to select the product to acquire (the different options and their prices are displayed on screen), in this case, the different amounts of TAE purchases are displayed.

The purchase of intangible products may be made with the AE2.0 module through four different payment methods: magnetic stripe reader (debit or credit), smart card (chip), proximity card (NFC), and cash. The user must select one of the above methods of payment to complete its purchase using the keypad.

If payment is in cash, the module requests the exact amount. Otherwise, it requests that the card be swiped, inserted, or placed on the reader, whichever applicable. After the money has been deposited, the module requests that the ten digit cellular phone number be entered. It then requests confirmation of the number, and finally requests that the information be reviewed and accepted. Once the user accepts, the module communicated with ServerV to request the corresponding purchase. Once ServerV obtains a response, it returns the information to the module with a response code and an authorization number for the pre-paid air time purchase if successful.

When payment is made with any type of card, its information is sent through a TCP connection to ServerV through the communication device available (modem, WiFi, or Ethernet), to verify the credit balance and send a response indicating if the TAE purchase proceeds or not. If the operation is successful, ServerV returns the authorization number for the pre-paid air time purchase. The card's balance is modifies after the purchase has been made.

Purchase of Intangible Products: Payment of Services

The AE2.0 module has the function of receiving payment for third parties, in other words, payments of services such as phone or cable television bills, for example. To carry out this type of transactions, it is necessary to access the “Payment of Services” menu available in the AE2.0 module. The enter button must be pressed and the module's screen displays a menu for the operations that may be made. The user must select the option “payment of services”. Once the option has been select, the user may select the type of service it wishes to pay. The AE2.0 module requests that the user provide its client number to some reference code for the account that is to be paid. Once such information is entered, the means of payment must be selected. The means of payment have been described above.

If the user chooses to pay in cash, the AE2.0 module will request that the exact amount be provided. If the user chooses another means of payment, such as a magnetic stripe, smart, or proximity card, the user must slide, insert, or place the card on the module so that the corresponding payment may be made. Once the module reads the user's card, it will make a TCP connection with ServerV, which makes a request for payment for the account that the user selected and ServerV will respond to the module with an answer code and a confirmation number for payment. If the card does not have sufficient funds to complete the operation, the module will display on the screen that payment cannot be completed and will mention the corresponding reason.

Finally, the AE2.0 module prints a receipt with the information from the operation, including the place, date, time, detail of the payment made, and confirmation number.

Connection with TCP Client

So that the Internet modem may connect to a remote server, the MCU will send the following parameters: 1. Mode: in this case, it is shown that it is TCP (the UDP option is also available), 2. IP Address: It is the IP address of the remote server, 3. Port: It is the port through which the server receives requests from remote clients.

The following step is to wait for the response “CONNECT OK” on behalf of the MODEM, which informs the MCU that connection has been established. As of this moment, data packages may be sent and received.

The telemetry module provides ServerV (through a modem) the following requests or data packages: 1. Synchronization of current time and date, 2. Sending of Sales from the Vending Machine extracted from the DEX, 3. Sending of Alarms or Events from the Vending Machine extracted from the DEX, 4. Sending of the Sales at Closing from the Vending Machine extracted from the DEX, 5. Electronic Pre-paid air time Purchases.

Real Time Clock

One of the functions of the module's application is that it uses the modem to keep a Real Time Clock (RTC) backup, in other words, the modem receives the connection command from the server and it sends a request of current time, and the MCU through the time and date command configures the modem with the current time and date. Each time the module requires verification of the time and date, it does so through the modem, which delivers such information.

Sending of DEX Information

The MCU is in charge of establishing communication with the Vending Machine Controller (VMC) each time the pre-programmed time is completed, both with sales as with alarms. This information is located in a DEX file that the VMC stores and sends to the AE2.0 module.

When the module has to send information from the DEX, it requests the time and date to the modem and then tries to establish communication with the remote server. If connection is successful, the module will request the VMC to deliver the DEX, and once it has stored it in its memory, the MCU will ask the modem to send the information (in 1 KB packages) that it just extracted from the VMC and will wait for a response from the server for each package sent. When sending is complete and information has been confirmed, the MCU will request from the modem that it close the connection with the server and the modem will be ready to again configure itself in server mode and be ready to listen to requests from remote clients. It is worth mentioning that the modem only closes the TCP connection with the server, the network connection that it has with the APN is maintained active.

Electronic Pre-Paid Air Time Purchases

The module possesses an interface that allows it to interact with the user through an LCD screen and a 16 button keypad. The characteristic of interacting with the user provides the opportunity of making some operations directly with the module, such as sending closings of sales, purchases of products without the need for cash, etc. The module has been implemented with the sale of TAE where the user, through a series of simple steps, selects the amount of pre-paid air time that it wishes to purchase, inserts money into the same Vending Machine, and if everything is correct, the module carries out the transaction with the server.

Once the user has entered the amount of purchase and confirmed the telephone number to which the pre-paid air time purchase will be credited, the MCU instructs the modem to establish communication with the server, to sent the purchase request with the information captured by the module. The server will respond to the modem depending on the response from the telephone service provider. Finally, if everything turned out successful, the user will see in the screen the authorization number for its purchase and the operation is concluded.

TCP Server Connection

The modem may be configured in server mode in a determined port to be ready to receive petitions from remote clients. The modem normally works under this scheme unless it has to carry out another programmed operation.

The petitions that the module may work on under this scheme are the following: 1. Updating of firmware, 2. Obtaining prices, 3. Change in prices, 4. Configuration of parameters, 5. Obtaining parameters, 6. Sending Alarms or Events, 7. Sending of Sales, 8. Sending of Sales at Closing.

Each of these requests has a certain identification code in the range of data that the MCU detects, and performs the corresponding operation according to what is requested, in other words, a communication protocol is followed between the module and the web services.

Firmware Updates

The remote updating of the firmware consists in the sending of packages from a web service called: WSteleinter towards the module. Such packages contain the data from the corresponding .hex file with the update, which is gathered from the MCU's source program. Once the modem receives an update firmware request, the MCU writes in the EEPROM memory the change in status in the remote update flag and restarts the application so that when the main program initiates, the flag is detected as on and the MCU makes a leap towards the program index and heads to the “Bootloader” region of the MCU. In such region, the program where data packages are received from the WSteleinter is found, and each one of them is confirmed so that the next one may be sent. Once the information is received, the MCU will write it beginning on the second half of its Flash memory. This is made to prevent erasing the last functional update and prevent a wrong functioning if the data arrives corrupted or incomplete. When the modem detects that the last package arrives, the MCU trespasses the information it stored in the second section of the memory onto the first section, which is where the new main program runs. When the new main program has been completely written in the Flash memory of the MCU, the module is completely restarted, now starting up with the new application.

Obtaining and Assigning of Prices in the Vending Machine

When the modem receives a request for obtaining prices, the MCU establishes communication with the VMC to obtain the DEX and from there gather the product prices so that these may be sent with a set of required information by the WebService (WSteleinter).

When the modem receives a request for establishing new prices, the MCU establishes communication with the VMC to send through a DEX format the new prices for each product, and this information is received and confirmed by the VMC and the modem answers with a response of operation completed to the WebService (WSteleinter).

Assignment of Minimum Product Quantities in Vending Machine

When the modem receives a set of data from the server, corresponding to the minimum values for products that the vending machine (Vending Machine or VM) must contain, the microcontroller (MCU) stores such values in its memory and compares them when it automatically extracts the DEX. If the minimum value for the VM's products is reached, the module (through the modem), sends a normal Sales report and an additional one with a minimum product Alarm.

Configuration and Obtaining Parameters from the Telemetry Module

When the modem receives a request for configuration or establishment of parameters, the MCU detects the range of parameters being received and stores them in the external Flash memory, so that they can then be established in the EEPROM memory as configuration parameters, such as: ServerV's IP, ServerV's Port, frequency of sales or alarms communications, VM's address, etc.

When the modem receives a request for obtaining parameters, the MCU reads all parameters in the EEPROM memory that have been previously defined in the communication protocol and sends them as responses to the WSteleinter so that they can be visualized.

Sales Request, Alarms, and Closings of the Vending Machine

When the modem receives a sales or alarms request from the VM, the MCU identifies the plan received by the modem and at that time establishes communication with the VM to obtain the DEX so that it can send the required sales information to the WSteleinter through the modem, which will be waiting for confirmation of a correct processing of the plan.

When the modem receives a request for closing of sales from the VM, the MCU identifies the plan received by the modem and at that time establishes communication with the VM to obtain the DEX to then be able to send the requested sales information to the WSteleinter. The information sent will have an identification number which tells us at that at such time there was a closing in sales. The modem will remain waiting for confirmation of correct processing for this information.

It is worth mentioning that the modem will not send all of the information within the DEX, instead it will only store in the Flash memory the DEX fields that are required at that time, whether they are Sales, Alarms, or Events fields of the VM.

### Functioning of the AE2.0 Module

As mentioned in the previous section, the AE2.0 module operates based on an RTOS that allows it to operate as a multitask device. However, before initiating the available tasks, a series of routines for system start-up are performed.

When the module AE2.0 application initiates, it reviews if it seeks to update itself. If affirmative, a function called “bootloader” is commenced, which receives data from the new application through a serial port and stores them in a section of the FLASH memory. Such FLASH memory is manipulated in 2 sections: the active section and the backup section.

The new application received by the serial port is stored in the backup section. This is made to prevent a possible disconnection of the system while it is being updated. If the system loses connection and does not receive the full update, then the non-updated application continues working as if the update was not attempted, because it is still stored in the active section. On the contrary, if the new application is received successfully, it proceeds to copy the data from the backup section onto the active section (re-writing over the previous application). Once the process is complete, the new application takes control over the system.

On the other hand, if the system does not receive a request for an update, then it continues with its connection of the modem to the APN as previously described. Once connected to the network, a connection with ServerV is established. If this last connection is not established, then it displays error “5000” in the upper left section of the screen. Otherwise, it displays a “0” that shows the connection with ServerV was successful.

With what has been mentioned so far, the initialization phase of the module is complete, and we proceed with the organized performance of the tasks explained beforehand. From hereon, the functioning of the module will be directed by a series of events that may occur at any moment.

The events that direct the functioning of the module are: 1. Pressing a key, 2. Receiving a request on behalf of any TCP client, 3. Compliance of pre-programmed time to send an alarm or inventory. Pressing a key: This event may trigger different functions, according with the option selected by the operator. These functions are: 1. Make a TAE purchase, 2. Configure module parameters, 3. Request inventory extraction, 4. Request extraction of alarms and inventory, 5. Configure sending of alarms and inventory, and 6. Request a firmware update. Reception of a request on behalf of a TCP client: These functions are: 1. Configuration of module parameters, 2. Request extraction of inventory, 3. Request extraction of alarms, 4. Configure sending of alarms and inventory, and 5. Request firmware update.

Description of Communication Protocol VM/ServerV/WS

Communication protocol VM/ServerV/WS was Developer to allow for the transmission and interpretation of critical data between the telemetry module AE2.0 and the Backoffice sections: ServerV and WSteleinter. The name VM/ServerV/WS is in reference to the Vending Machine (or VM), the ServerV and the Webservice WSteleinter. The data travels wirelessly using the cellular network via GPRS, EDGE, TD-SCDMA, HSDPA, 3G, 3GPP LTE, or any current cellular technology. For there to exist communication, three parts are required: 1. A group of AE2.0 telemetry modules with unique identifications. 2. Applications for Windows: ServerV and WSteleinter, which are installed within a remote server, 3. An access to an APN network (Access Point Name) that encompasses the telemetry modules and the server. Such APN establishes fixed IP addresses to each module with the purpose of having the Backoffice system storing them in a database and hence making the connection more agile.

Functionality

The telemetry modules AE2.0 possess a GPRS communications port through a modem. The GPRS modem, through its SIM card, possesses a port and a fixed IP within the APN network. The WSteleinter y ServerV applications relate their IP addresses with an alias or a unique identification (ID) to process the transactions and move them to an operational level.

Communication is established among one or various clients and a server. The telemetry module may operate in any of both modes (client or server). The forms of operation are described as follows:

1. AE2.0-cliente/ServerV-servidor and,

2. AE2.0-servidor/WSteleinter-cliente.

1. AE2.0-Client/ServerV-Server

The telemetry module AE2.0 self-configurates in client mode each time it wants to make a request for data from the ServerV application, such as: time synchronization, sending of inventories and alarms, etc.

2. AE2.0-Server/WSteleinter-Client

Most of the time the telemetry module is configured in server mode, with the purpose of working with clients that need to connect to it through WSteleinter. For example: when a client application intends to change configuration of a telemetry module in particular. In this case, the client connects to the WSteleinter as an intermediate layer of communication to the telemetry module; the WSteleinter acknowledges the IP address and listening port of the intended module, and the steps to follow to make the change in configuration.

Layers

Communication must be established between the AE2.0 telemetry module and the Webservice WSteleinter. To achieve this, the use of some communication layers and protocols is required.

The data transmitted in communications protocol VM/Server/WS travel through layer TCP/IP in packages of 1 kByte in size. The format of protocol data is based on specifications ANSI X3.28. In order to establish Client-Server communication, the client must know 3 things: the communication protocol (TCP/IP in this case), the IP address, and the server listening port to open a socket.

Protocol

The request for information may be made from the WSteleinter to the telemetry module AE2.0 or from the telemetry module AE2.0 to the ServerV application. When a request is made, the first frame of data that travels from client to server has the following structure:

### STX\Dato\ETX

Where “STX” is the leading byte and its value is 2 in hexadecimal (or 02h), “ETX” is the end byte and its value is 03h, and “Dato”, which has different values depending on the type of request in hexadecimal, as shown below:

### DEXInventario=10h, BOOTLOAD=12h, ALARMA=20h, CORTE=30h, SETCONFIG=40h, GETCONFIG=45h, GET MAX MIN=50h, CAMBIOPRECIO=60h, GET PRECIO=65h.

Data Response

The telemetry module (in server mode) or the application (ServerV) returns the requested data to the client (based on the type of request shown above) in a frame of data. Such frame is divided into two parts: heading and data. The heading contains information about the vending machine and the event. The data correspond to the type of request sent.

### Encabezado\Datos

The client must confirm that the data was received correctly or incorrectly by the server. To do so, the server responds with a frame of confirmation data composed of 4 fields:

### Encabezado\Ok\0\*

As already mentioned, the heading contains information from the vending machine and the event. Field 2 contains an “Ok” that confirms receipt of data. Field 3 contains a number that displays the error code (if a “0” it means that there were no errors and the information was received correctly). The last field contains an asterisk that displays the end of the frame.
Both the response data frames as well as the confirmation receipt of data share the same heading format, which is made up of different elements. Such elements are located in 6 fields divided by the character “|” as demonstrated below:

### IC|TipodeTrama|IDVending|FechaHora|Num.Trama|Num.Paquete

The field “IC” is the identification number of the frame, the “TipodeTrama” displays the type of request, the “IDVending” field is the vending machine identification, the “FechaHora” field contains the date and time of the event, the field “Num.Trama” contains the number of frames that conform the full package of the data frame, the field “Num.Paquete” displays the number of package that is being sent.

The data is framed by 01h bytes and at the end by the pipe character “|”. The number and types of fields depend on the date.

Below are the options that the field “TipoTrama” may have: inventory, alarms, configuration of the telemetry module, obtaining fields of configuration of the telemetry module, price assignment, price search, placement of minimums-maximums, and time synchronization.

Inventory Frame

Below is the data that must be included in the inventory frame:

[0x01]-[Totalizadores]-[0x01]-[Selección Precio y Ventas]-[0x01]-[Selección/Carril]-[\]
The first field shows total sales, (including those made since the last resetting of the control card, as well as those made since commencement of operation). The second field shows the sales made since the last extraction of inventory by lane. The third field shows the association between the selection/lane.

Alarms Frame

Below is the form of the data frame for alarms:

[\]-[Evento 1 y detalles]-[&]-[Evento 2 y detalles]-[&]- . . . -[Evento n y detalles]-[&]-[\]

The alarms frame separates each of the events with character “&” (ampersand). The events and their details have the format that displays the standard of transfer of EVA (European Vending Association) data. However, many manufacturers do not abide by the standard and generate their own codes, in such a way that in many cases it will be necessary to resort to their documents to interpret the frames sent.

Closings Frame

Below is the data that must be included in the closings frame:
[0x01]-[Totalizadores]-[0x01]-[Selecciones]-[0x01]-[Selección/Carril]-[\]

It is composed of 3 fields: The first field displays total sales (including those made since the last resetting of the control card, as well as those made since commencement of operation). The second field shows the selections for each of the lanes. The third field shows the association between the selection/lane.

Configuration of the Telemetry Module Set

Below is the data that must be included in the module configuration set:

IP|Puerto|APN|Usuario|Contraseña|Id_VM|NoSVM|Modem|Id_modem|F abM|IMEI|IMSI|SIM|TimeIn|TimeEv|MiniPro|ID_VM|Cnt_tramas|Hrs. Ini|Hrs.Fin|*03h

The fields are divided by the character “|” and contain the following information. 1. Unique IP Address, 2. Communications Port, 3. Name of the APN (Access Point Name), 4. User name (only if it so exists), 5. Password (if any), 6. VM Identification Number, 7. VM's serial number, 8. Modem brand and/or model, 9. Modem identification number, 10. Name of modem manufacturer, 11. IMEI or International Mobile Equipment Identity, 12. IMSI or International Mobile Subscriber Identity, 13. SIM telephone number, 14. Time expected for sending of events or alarms, 16. Product minimum, 17. Confirmation of identification number for the VM, 18. Number of frame sent, 19. Time of commencement in which the module may send inventories and scheduled alarms, 20. Final hour when the module ceases sending inventories and scheduled alarms.

Price Search

The fields are divided by the character “&”. Each selection displays its price and concludes with the character “*”.

Selección1 & Selección 2 & . . . &Selección n& |0|*

Price Assignment

The same format for searching prices is used to assign them, but with the distinction that it ends with the byte 03h.

Selección1 & Selección2 & Selección n & |0x03

Assignment of Minimums and Maximums

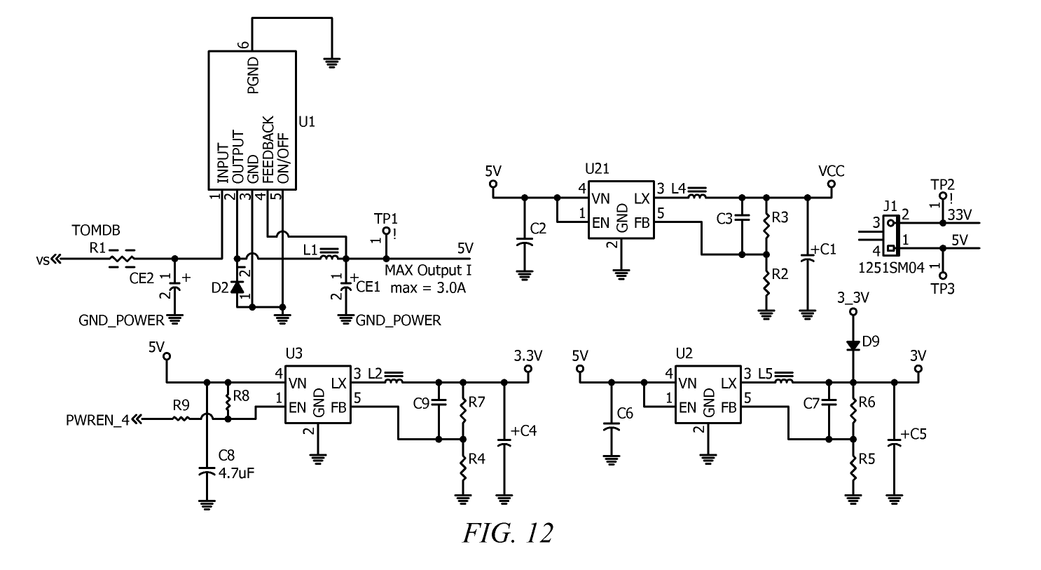

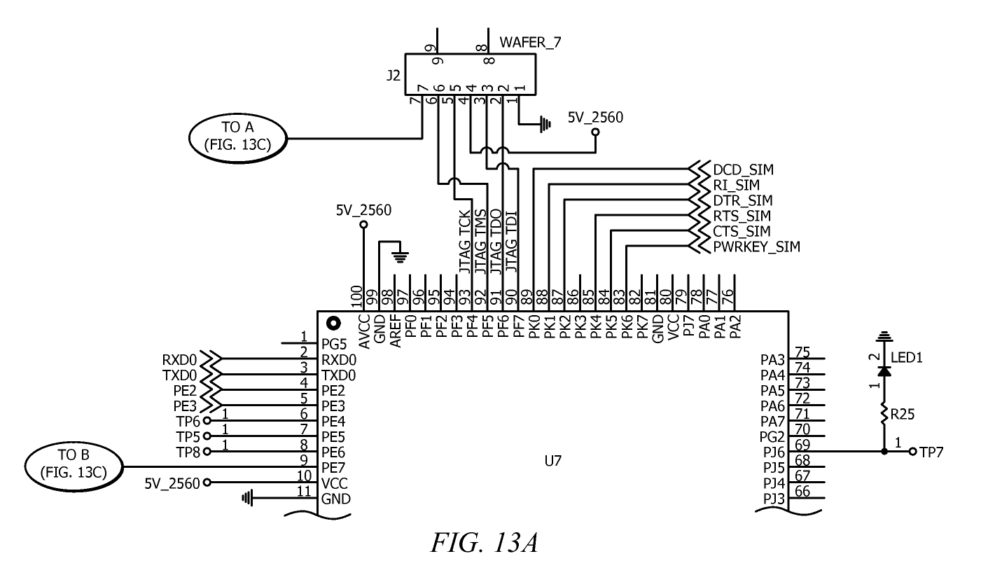

The data frame of maximums and minimums is divided by the character “&” as seen in FIG. 12, each selection displays the minimum, maximum, and code that will be established per each selection, the frame ends with the byte 0x03 in hexadecimal.

Selección1 & Selección2 & Selección n & |0x03

Description of the Fields in the Schedules

Sending of Inventory Directly from the VM to ServerV (Data Set)
83|1|4|15/12/10
17:18:57|685|1|1| {1}500*5*0*0*{1}1*100*4*400*0*0&2*100*0*0*0* 0&3*100*0*0*0*0&4*100*1*100*0*0&5*100*0*0*0*0&6*100*0*0*0*0&7*100*8*9995*9*9995*10*9995 *{1}1*1&1*2&2*3&3*4&4*5&5*6&6*7&7*0&8*0&9*0&10*0&11*0&|
Below is an analysis of the fields in the data block that is sent by the telemetry module to ServerV.
83| Sending of data from the telemetry module to ServerV, 1| Type of DEX: Inventory, 4| Vending ID, 15/12/10 17:18:57| Date and Time of Transaction, 685| Consecutive Transactions number, 1| Number of packages to send, 1|, Number of current package, {1} Divider 1 in Hexadecimal, 500* Quantity in accumulated total money since commencement of operations, 5* Amount of total products since commencement of operations, 0* Amount of total money since latest reset, 0* Amount of total products since latest reset, {1} Divider 1 in Hexadecimal, 1*100*4*400*0*0*20100823*071535*0& Selección 1, price, 4 sales since commencement of operations, $400 since it last operated, 0$ since last closing, 0 products sold since last closing or reset, Field PA5 (product empty) 20100823=displays date 2010/08/23, the field 071535 displays the time 07:15:35 and the last field “0” displays the number of times that a product which had run out was requested. The following fields up until 7*100*8*9995*9*9995*10*9995*0*0* are similar to the past, {1} Divider 1 in Hexadecimal, 1*1&1*2&2*3&3*4&4*5&5*6&6*7&7*0&8*0&9*0&10*0&11*0&| Selección 1 is associated to the lane 1, Selección 1 is associated to the lane 2, Selección 2 is associated to the lane 3, Selección 3 is associated to the lane 4, Selección 4 is associated to the lane 5, Selección 5 is associated to the lane 6, Selección 6 is associated to the lane 7, Selección 7, 8, 9, 10, y 11 do not have any associated lanes.

### Response on Behalf of ServerV to the Telemetry Module (Sending Scheduled by “Direct Inventory” (Data Set)

84|1|4|11/10/10 21:19:14|9|1|1|ok|0|
Below is an analysis of the fields in the data block that is sent by the VM to ServerV.
84| Sending of data from ServerV to VM, 1| Type of DEX Inventory, 4| Vending ID, 11/10/10 Date and time of the transaction, 21:19:14| Number of consecutive transactions, 9| Number of packages to be sent, 1| Number of current package, 1|, ok| Response from ServerV, 0| Displays there were no errors, Any different number means an error code.

### Sending of Alarms to ServerV (SV) (Data Set)

### 50|1|8818|15/12/10 16:56:34|6|2*CR*0*&2*DO*10*&|

50| Sending of Alarms to SV, 1| Type of DEX: Alarm, 8818| Vending ID, 15/12/10 16:56:34| date and time of transaction, Number of consecutive transactions, 2*CR*0*&2*DO*10*&| Response from ServerV. 0 Displays there were no errors, Any different number means an error code.
Response from SV (Alarm)
60|1|id_vm|fecha hora|folio_trama|ok|código_respuesta|*
Example: 60|1|9928|04/01/11 18:25:21/4|ok|0|*

### Direct Closing (Data Set)

83|2|8818|15/12/10
17:03:31|7|1|1| {01}200*1*200*1*{01}1*0*0*0*0*0&2*0*0*0*0*0&3* 0*0*0*0*0&4*0*0*0*0*0&5*0*0*0*0*0&6*0*0*0*0*0&7*0*1*200*1*200&8*0*0*0*0*0&{01}1*1&1*2&1*3&2*1&2*2&2*3&3*4&3*5&4*4&4*5&5*6& 6*7&7*8&8*1&8*2&8*3&1

### Analysis:

83| Direct Closing for the VM, 2| Type of DEX: Direct Closing, 8818| Vending ID, 15/12/10 17:03:31| Date and time of transaction, 7| Number of packages to send, 1| Number of current package.

### Module Configuration (Data Set)

{02}40|4|01/12/10
10:48:31|10.1.6.91|9001|arcavng.itelcel.com∥|D000>000|VEC 12.2|SIMCOM_SIM300|D12 GPRS

### DTU|SIMCOM_Ltd|354777030994227|334020264027660|8199887766|4|1 83|3|12|60000|7|8818|1|9:00|20:00|*{03}

### Analysis:

40| Direct Closing for the VM, 4| Type of DEX: Direct Closing, 01/12/10 10:48:31| Date and time of transaction, 10.1.6.91| IP of test server, 9001| Communication port arcavng.itelcel.com| ∥A.P.N., 8818| Vending ID.

### Module Response (Configuration of VM) (Data Set)

75|8818|15/12/10 17:06:02|

### Analysis:

75| Response from VM to Server (Module Configuration), 8818| Vending ID, 15/12/10 17:06:02| Date and time of transaction. Response from VM to Server (Module Configuration)

### Obtain Configuration of VM (Data Set)

75|8818|15/12/10 17:06:02|

### Analysis:

75| Response from VM to Server (Module Configuration), 8818| ID Vending, 15/12/10 17:06:02| Date and time of transaction.
Response from VM to SV (Obtaining Configuration) (Data Set)
11|9928|15/12/10
17:13:25|10.1.6.91|9001|arcavng.itelcel.com∥|D000>000|VEC 12.2|DTU Series|D12 GPRS DTU|WIRELESS CO|358987010052195|52952503786|8199887766|180|180|3|12|60000|1|16777215|1|6:30|23:30|V1.2.1∥

### Analysis:

11| Response from VM to ServerV (Module Configuration) 16777215| Vending ID, 17:13:25| Date and time of transaction, 10.1.6.91|9001| Communication Port, arcavng.itelcel.com∥| A.P.N., V1.2.1∥ Firmware Version.

### Assignment of New Prices (Data Set)

65|4|15/12/10

### 18:47:25|1*500*&2*500*&3*500*&4*500*&5*500*&6*500*&7*500*&8*5 00*&9*500*&10*9995*&∥0|*

### Analysis:

65* Response from VM to Server (Module Configuration), {03} ID Vending, 15/12/10 18:47:25| Date and time of transaction.

### Price Search (Data Set)

65|4|15/12/10

### 18:47:25|1*500*&2*500*&3*500*&4*500*&5*500*&6*500*&7*500*&8*5 00*&9*500*&10*9995*&∥0|*

### Analysis:

### 65| Response Code Obtain Prices, 4| ID Vending, 15/12/10 18:47:25|

### Assignment of New Maximums and Minimums in the Vending Machine (Data Set)

### {02}50|8818|Fecha

hora|1*3*24*1&2*4*30*1&3*3*30*1&4*3*30*1&5*4*3*1&6*3*30*1&7*3*30*1&8*3*30*1&9*3*30*1&10*3*30*1|*{03}

### Analysis:

{02} Response from telemetry module to ServerV (Module Configuration), 50|8818| Vending ID, Date, time Date and time of transaction.

### DESCRIPTION OF FIGURES

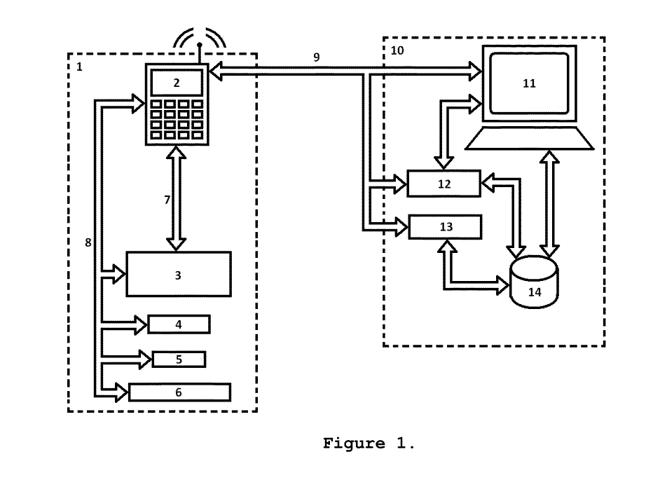

FIG. 1 illustrates a general diagram of the telemetry system. The blocks that make up such system are: Vending machine (1); telemetry module (2), Vending machine control card (3), Coin slot (4), Bill slot (5), Other peripherals (6), DEX Communication (7), MDB communication bus (8), Wireless communication (9), Back office (10), Vendvolution application (11), WSTeleinter Web service (12), ServerV Application (13), Database (14).

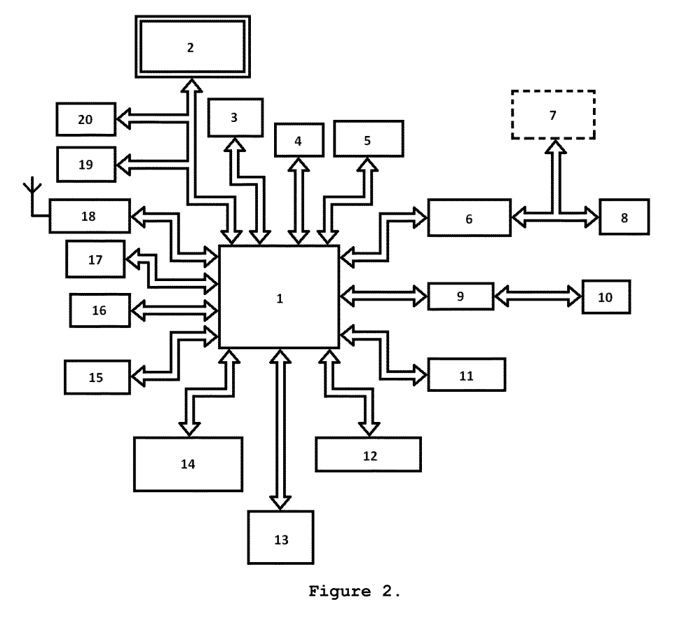

FIG. 2 illustrates a scheme of the telemetry module's composition. The blocks that compose it are: Microcontroller (1), LCD Screen (2), WiFi Port (3), NFC Port (4), Bluetooth Port (5), MDB slave circuit (6), External power supply (7), MDB Port (8), Reliever (9), DEX Port (10), RS-232 Series Port (11), Chip card Reader (12), Numerical keypad (13), magnetic strip card reader (14), thermal printer (15), Ethernet port (16), ADC channels 17), Wireless Modem (18), Flash memory 1 (19) and, Flash memory 2 (20).

Although this last figure is composed by 20 blocks, a functional application will only possess some of them. The reason for this is that some of the blocks perform a function that is equivalent to another's. For example, the WiFi block, performs the same function than the Ethernet block, but one does it through wireless means, while the other does not. The option of placing or not placing a certain block will depend on the customer's decision and budget.

Put into different words, a telemetry module that possesses all of the hardware described in the blocks of FIG. 2 would be expensive and some blocks would be redundant and may even not be used. However, the purpose of offering all of the described options is providing the customer with a variety of possibilities so that the customer selects those that better fill its needs, and thus, the hardware acquired becomes personalized and at a more competitive price.

The function of the telemetry module, generally described would be as follows: A. Interaction with the vending machine by means of its DEX and MDB ports with the functions for cash payment, product or service selection, extraction of alarms and inventories, etc. Interaction with the Back office through an APN network by means of the wireless modem for the exchange of management and operational data, C. Interaction with the user by means of the keypad and the screen to carry out TAE purchases, attention on resupplying, etc., D. Direct interaction with the development personnel through a PC or laptop by means of a serial port, to carry out tests for the incorporation of new characteristics to the system, and E. Interaction with the user through different devices that allow for the payment of products or services requested (for instance, through chip or magnetic strip readers).

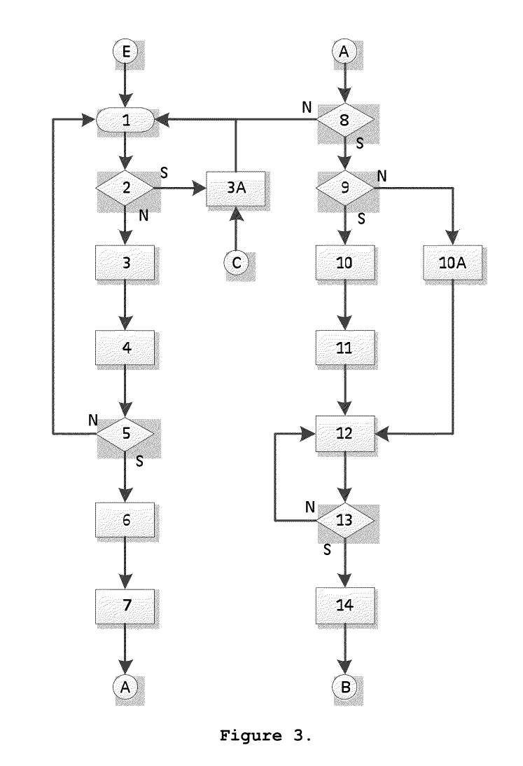

FIG. 3 illustrates a flow chart that describes the initial part of the telemetry module firmware's general functioning. Below is a description of the elements that it comprises: 1. Startup (this is when the entire operation begins), 2. Update Firmware? This block asks if the firmware is to be updated, 3. Initialization of peripherals. This is when all of the peripherals that make up the microcontroller are initialized: DEX, MDB, and SPI Ports, etc., 3A. Carry out firmware update. This action stores a new version of the firmware in the program's memory, which begins to operate immediately after the module has been restarted, 4. Initialization of operational system tasks. Whether the tasks are used or not, these are initialized in this block, 5. Is SIM Card inserted? Review that there exists a valid SIM card in the corresponding port, 6. Configuration of connection parameters. These parameters correspond with the APN network to which connection is intended, 7. Connection to APN, 8. Connection successful? Verify connection with APN, 9. Connection to ServerV? Verify connection with ServerV application, 10. Time and date synchronization. Obtains correct time and date from network, 10A. Display in main screen with connection number error, 11. Connection in server mode, 12. Display on main screen (standby mode), 13. Is OK button pressed? The OK button is shown with a check mark, 14. Display of main menu. This menu shows options for purchase of pre-paid air time, although it also allows for input of passwords for system operation.

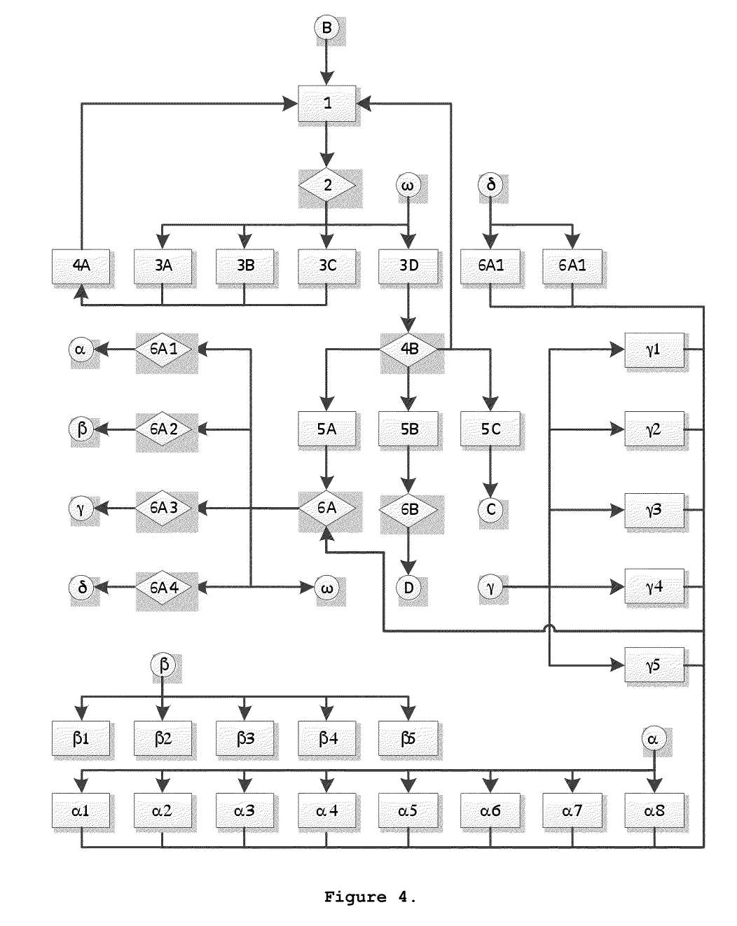

The flowchart of FIG. 4 illustrates the form of purchasing TAE, in addition to inputting different passwords that permit access to some operational or service functions of the telemetry module. Such passwords are only known by authorized personnel. As an additional form of safety, the menus in the telemetry modules never provide the option of inputting a password. The moment to input the password is previously known by the personnel in charge.

FIG. 4 illustrates a flowchart that describes the menus of the telemetry modules. The elements that make up this diagram are: 1. Display of amounts for pre-paid air time purchases available to user, 2. Was any pre-paid air time purchase amount selected, or was the general password entered? 3A. Wait until amount A has been entered, 3B. Wait until amount B has been entered, 3C. Wait until amount C has been entered, 3D. If the general password was entered (3D), wait until password A, B, or C is entered, 4A. Carry out selected TAE purchase and return to main screen, 4B. Was password A, B, or C entered? 5A. If password A was entered, display menu information with options: 1) GPRS MODEM, 2) VM INFORMATION, 3) OPERATION, 4) TAE PURCHASES. 5B. If password B was entered, display menu MODEM ID, 5C. If password C was entered, initiate update of “firmware” through “bootloader”, 6A. Was any option from menu 5A selected? If negative, return to block 3D, 6A1. If 1) GPRS MODEM was selected, display its corresponding menu: 1) MODEL, 2) MODEM ID, 3) MANUFACTURER ID, 4) IMEI, 5) IMSI, 6) SIM, 7) SIGNAL LEVEL, 8) IP MODULE, 6A2. If 2) VM INFORMATION was selected, display its corresponding menu: 1) VENDING ID, 2) SERIAL NUMBER 3) MODEL, 4) AUTOMATICALLY SENT ITEMS, 5) LOG, 6A3. If 3) OPERACIÓN selected, display 1) INVENTORY, 2) ALARMS, 3) CLOSING, 4) DEFAULT VALUES, 5) CLOCK, 6A4. If 4) TAE PURCHASES selected, display 1) TIMEOUT, 2) PRE-PAID AIR TIME PURCHASES COUNTER, α1. If 1) MODEL selected, display model of modem, α2. If 2) MODEM ID selected, display the modem's identification number, α3. If 3) MANUFACTURER ID selected, display the name of the modem's manufacturer, α4. If 4) IMEI selected, display the International Mobile Identity Number. α5. If 5) IMSI selected, display the International Mobile Subscriber Identity number. α6. If 6) SIM selected, display the telephone number of the inserted SIM, α7. If 7) SIGNAL LEVEL selected, display the percentage and level of RSSI (Receive Signal Strength Indication), α8. If 8) IP MODULE selected, display the IP address assigned by the APN to the telemetry module, β1. If 1) VENDING ID selected, display the VM's identification number, β2. If 2) SERIAL NUMBER selected, display VM's serial number, β3. If 3) MODEL selected, display VM's model, β4. If 4) AUTOMATICALLY SENT ITEMS selected, it allows for the editing of the time in seconds of the automatic sending of inventories and alarms, β5. If 5) LOG selected, extraction of logs commences, γ1. If 1) INVENTORY selected, it allows for the sending of an inventory to the Back Office, γ2. If 2) ALARMS selected, it allows for the sending of an alarms report to the Back Office, γ3. If 3) CLOSING selected, it allows for the sending of the last closing made to the VM, γ4. If 4) DEFAULT VALUES selected, it allows for the reestablishment of the default values of the telemetry modules, γ5. If 5) CLOCK selected, it displays the current date and time of the system, δ1. If 1) TIMEOUT selected, it displays the time expected to perform a purchase of pre-paid air time, δ2. If 2) PRE-PAID AIR TIME PURCHASE COUNTER selected, display the amount of pre-paid air time purchases made in the telemetry module.

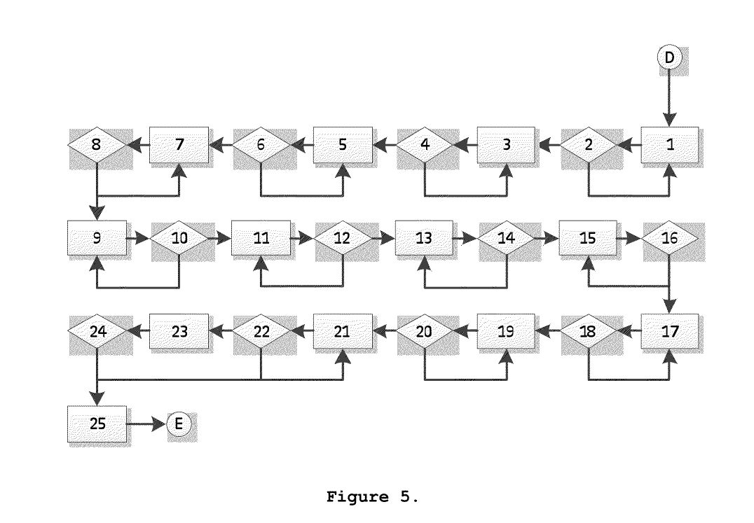

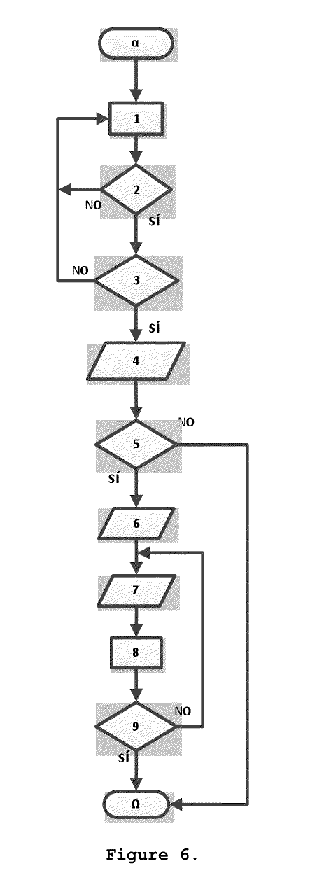

FIG. 5 is the continuation for the flowchart in FIG. 4. Such flowchart describes the form of configuring certain parameters of the telemetry module. The elements that make up this figure are: 1. Edit the modem ID, 2. Select step 3, 3. Edit the SIM telephone number, 4. Select step 4 or 2, 5. Edit the vending machine ID, 6. Select step 7 or 5, 7. Edit the telemetry module's IP address, 8. Select step 9 or 7, 9. Edit the port to which the module is to be connected, 10. Select step 11 or 9, 11. Edit the modem's listening port, 12. Select step 13 or 11, 13. Edit the sampling of inventories time, 14. Select step 15 or 13, 15. Edit the sampling time of alarms, 16. Select step 17 or 15, 17. Edit the time when sending is to begin, 18. Select step 19 or 17, 19. Edit the time when sending is to end, 20. Select step 21 or 19, 21. Display the signal level in percentage and RSSI, 22. Select step 23 or 21, 23. Request module ID confirmation, 24. Ask if user wishes to return to step 21 or proceeds with step 25, 25. Store configuration data and make an extraction of DEX and sends. Once concluded, a review of the port is made and the module is restarted.

FIG. 6 illustrates the flowchart for the automatic sending of Sales or Alarms from the DEX extracted from the vending machine. The DEX information sent may be scheduled from 1 to 9,999 minutes. The elements that make up the diagram are: α. Startup, 1. Standby Mode. On this stage, the module is in a mode where it shows its main screen and is awaiting for a scheduled activity, a remote request, or direct interaction with the user, 2. Is the sending time within the predefined range? This stage is in reference to the fact that on the module it is possible to schedule (manually or remotely) the schedule range in which the module will send the Sales and Alarms to ServerV, 3. Minutes elapsed in sending? If the module verifies that the current time is within the schedule for sending and that the number of minutes for sending Sales or Alarms information has elapsed, it will proceed with the operation, 4. The module attempts to establish connection with ServerV, 5. Connection established?If connection with ServerV is successful, proceed with the extraction of the DEX, if there is no connection the process is concluded, 6. Extract the DEX from the VM, 7. Sends Sales or Alarms to ServerV, at this point, the module sends the information it just extracted from the VM, 8. Receives response from ServerV, at this point, ServerV has sent a data package confirming the frame that the module had sent, 9. Total of sent packages? The sending of DEX information generally requires more than one package, since occasionally the DEX is too extensive due to the number of selections available for the vending machines. The module determines how many packages it will send with the information. Once sending is complete, the process ends, Ω. End.

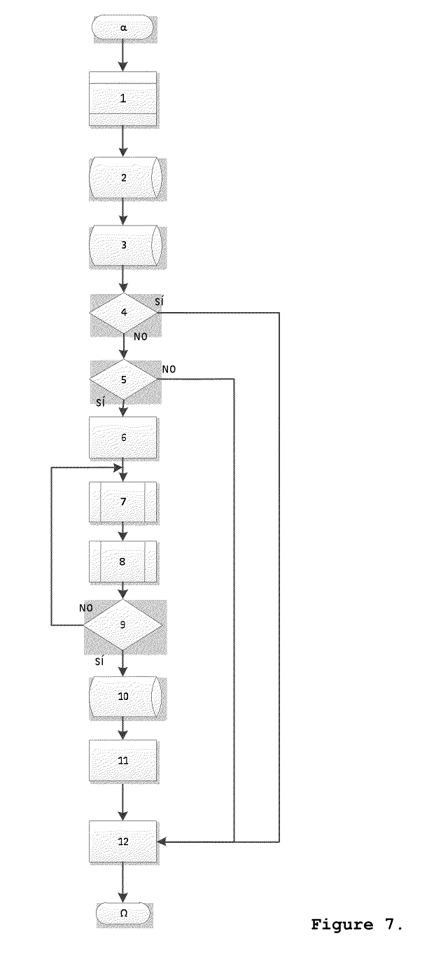

FIG. 7 illustrates the flowchart of the WSTeleInter WebService when it carries out an information request to the Telemetry module. As a requirement for there to be a connection between the WebService and the telemetry module, the module must be established in server mode at a certain listening port, in order to provide attention to any remote client. The WebService offers different methods or functionalities that may be used to obtain information such as: Sales, Alarms, Closings, VM (Vending Machine) prices, etc. Below is a description of the stages and components of the diagram: α. Startup, 1. Request of Information (Sales, Alarms, Closings, etc.). At this stage, information is requested from certain machine through a WebService method, 2. Obtaining of IP. In this phase, the WebService consults the Database to obtain the IP address of the machine that was requested, 3. Seeks VM's last registry. On this stage, the WebService will consult the Database to obtain the last registry of information that has been requested, 4. Registry less than X hours?, meaning, if the difference in hours between registry and actual time in the system is less than a certain number (previously configured), the WebService may deliver such information directly from the Database without the need to make a connection with the module (stage 12). The configuration of the number of hours is established in the configuration file “web.config” of the WebService, 5. Connection to the module. On this stage, the WebService attempts to establish a connection with the module through a predetermined port and the module's IP, if connection cannot be established, the WebService will deliver the latest information stored in the Database, 6. Request of Information to the Module. Here the WebService sends a request code to the module, which interprets it according to protocol, 7. Expecting requested information. The WebService waits for a certain time for the module to deliver the requested information in maximum 1 kbyte packages, 8. Receives information and processes it, in this phase the module receives the frame sent by the module and the WebService processes such information for its latter storage in the Database, 9. Total number of packages sent?, if the module has finished sending to the WebService the total number of packages that compose the information requested, it proceeds with storage of the information in the Database, but if all of the packages have not yet been sent, the WebService will wait for all of the remaining packages to arrive (stage 7), 10. Writes to Database. The WebService writes in the Database the information received and processed from the module, 11. Sends the response code to module. Once the information is stored in the Database, the WebService sends a response code as a result of the insertion of data, with “0” being the successful response code, 12. Delivery of information (SOAP). The WebService finally delivers information to the Back office in SOAP format (Simple Object Access Protocol), which is a standard protocol that defines how two objects in different processes may communicate through XML (Extensible Markup Language) data exchange.

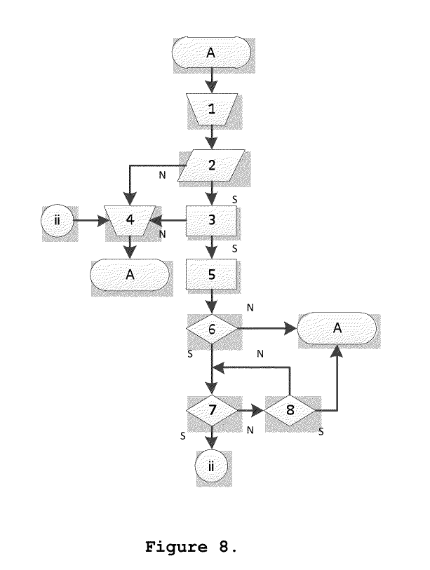

FIG. 8 is the flowchart for the first stage called: User, to perform a TAE payment.

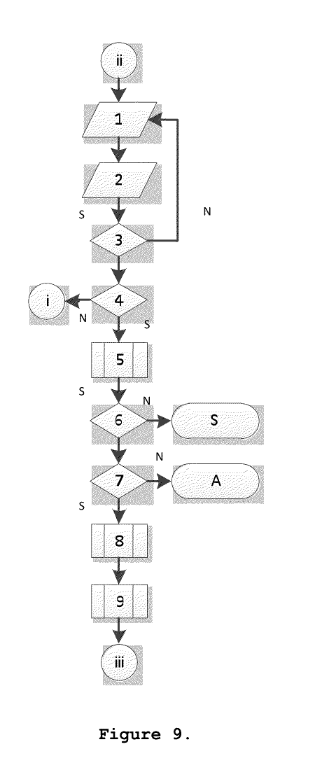

The elements that compose the diagram of FIG. 8 are: 1. Start pre-paid air time purchase (Pressing OK button). The user presses the OK button to start pre-paid air time purchase on the main screen, 2. Selecting the amount. The screen displays the prices of the different pre-paid air time purchases available, 3. 20 second timer to deposit money. The user has a time limit of 20 seconds to enter the exact amount for its pre-paid air time purchase, if time runs out, the transaction is canceled and returns to the main screen, 4. Cancel button. When selecting an amount, it is possible to cancel the operation at any time, 5. Login. Signs in to be able to purchase pre-paid air time, 6. Login, if login is successful, proceeds to process 7, otherwise, purchase of pre-paid air time is not possible and the appropriate error message is displayed, then returns to the main screen, 7. Amount equal to the amount deposited. If the user enters an amount of money equal to the amount charged, user continues to process ii, if the user enters an amount of money that is not equal to the amount charged, then the corresponding error message is displayed and returns to the main screen, 8. Timer expired for input of coins. If the user runs out of time, user returns to process 7, if the user enters an amount of money that is less than or greater than the amount shown, the corresponding error message is displayed, A. Main Screen, i. Cancel Button, ii. Continues in FIG. 9.

FIG. 9 is the flowchart for the second stage to perform a TAE payment and is the extension of FIG. 8.

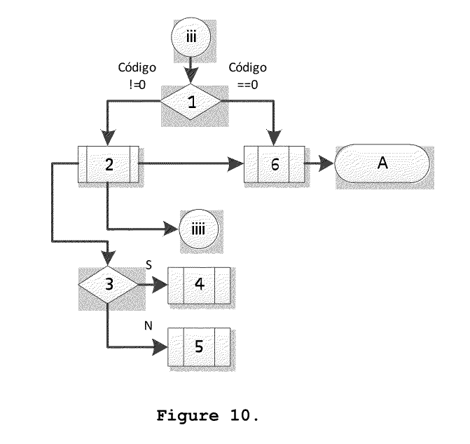

The elements that compose the diagram in FIG. 9 are: 1. Entering the phone number. It is a space where the user is asked to enter a 10 digit phone number for a pre-paid air time purchase, 2. Confirmation number. It is a space where the user is asked to confirm the 10-digit phone number, 3. Confirmation successful. If the user made a mistake while entering the mobile number, the appropriate error message will be displayed. If the user entered and confirmed the mobile number correctly, continues with process 4, 4. Confirm pre-paid air time purchase. At this stage the user can confirm or cancel the pre-paid air time purchase, 5. Opens socket in ServerV. This socket has a time limit of 60 seconds, 6. Communication with the server. If communication with the server is successfully continues with process 7, if instead the communication with the server fails, it shows the corresponding error message, then cancels the pre-paid air time purchase and returns to the main screen, 7. Comparison of selected amount with the amount deposited, if the user entered the amount of money equal to the amount, continues with process 8. If user did not input money or entered an amount less than or greater than the one selected, the appropriate error message will be displayed, 8. Vending Machine collects the money deposited. The module sends the RevalueAproved command to the vending machine so that the amount may be charged, 9. Sending data frame. The data frame is activated by the RevalueAproved command and has a timer of 60 seconds, A. Main Screen, S. Server. It is the server to which the module is connected to, i. Returns to the cancel button, ii. Extension of FIG. 8, iii. Continues in FIG. 10.

FIG. 10 is the flowchart for the third stage called: Transaction, to perform a TAE payment, and is the extension of FIG. 9.

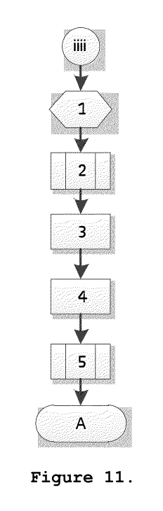

The elements that compose the diagram of FIG. 10 are: 1. Server response. If the server response is a code other than 0, process advances 2, if it is equal to 0, it displays the following messages: Transaction Successful. Authorization Number XXXX. Thank you for your preference, come back soon. 2. It displays an error code, 3. If the code is greater than or equal to 90 and less than or equal to 99, it displays error 9X on the screen, and if this condition is not met, then Error 16 is shown, 4. Error 9X: The Internet service provider is on maintenance, 5. Error 16: It was not possible to perform this transaction 6. Close communication with server. End communication with server after a successful transaction, then returns to main screen. A. Main Screen, iii. It is an extension of FIG. 9, iiii. Continues in FIG. 11.

The possible errors in step 2 are displayed on screen and are the following: Error 35: the telephone number entered is invalid, Error 66: Your pre-paid air time payment was not authorized, Error 87: telephone not subject to credit, Error 9X: the company that provides pre-paid air time is currently on maintenance, Error 2: machine not registered, Error 5: it was not possible to process this transaction, Error 16: it was not possible to process this transaction, Error 34: suspicion of fraud, Errors 8, 71 or 72: response was not received from the company that provides pre-paid air time, Error 67: you pre-paid air time purchase was not authorized, Error 30: error in message format.

FIG. 11 is the flowchart for the fourth stage called: Consultation, to perform a TAE payment, and is the extension of FIG. 10.

The elements that compose the flowchart in FIG. 11 are: 1. Structure of the consultation frame. In case of obtaining an Error Code 8 or 71, the module creates a consultation frame, and if anything different is shown, it displays process 2 errors, 2. Sending of frame for consultation. Sends consultation frame to the server 3. Expects response from the server with a timer equal to 120 seconds, 4. The consultation control flag is erased. After this, the module evaluates that it does not have any pending consultation, 5. Ending communication with server. This finalized the consultation process, A. Main screen, FIG. 11.

Electronic Diagram of Telemetry Module AE2.0

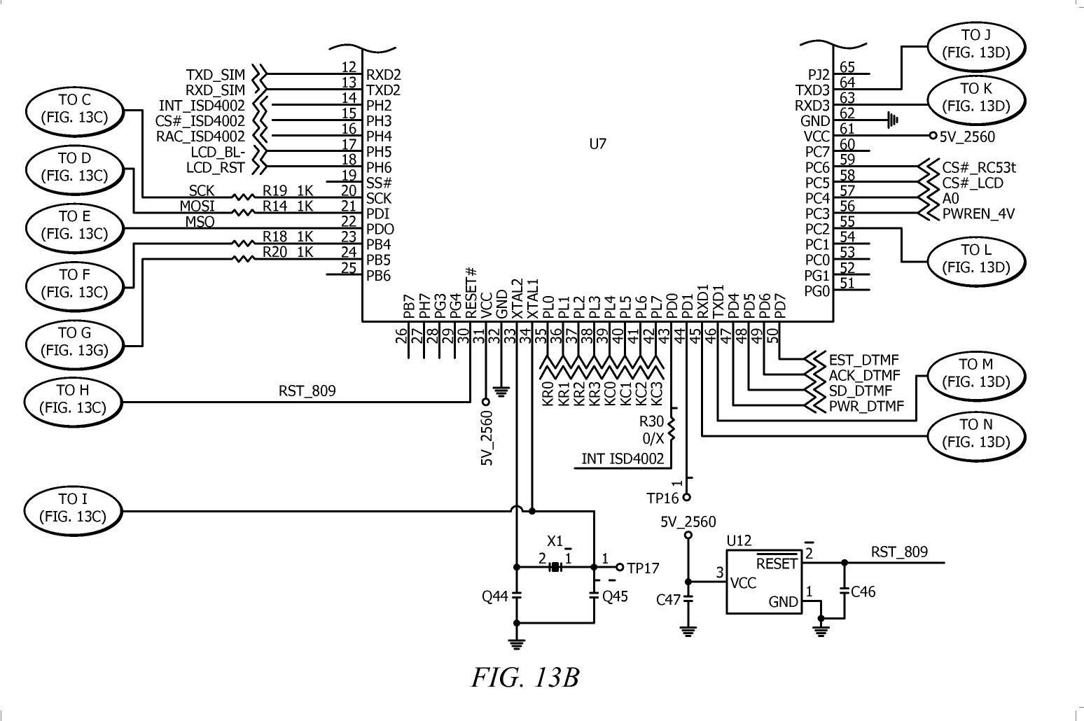

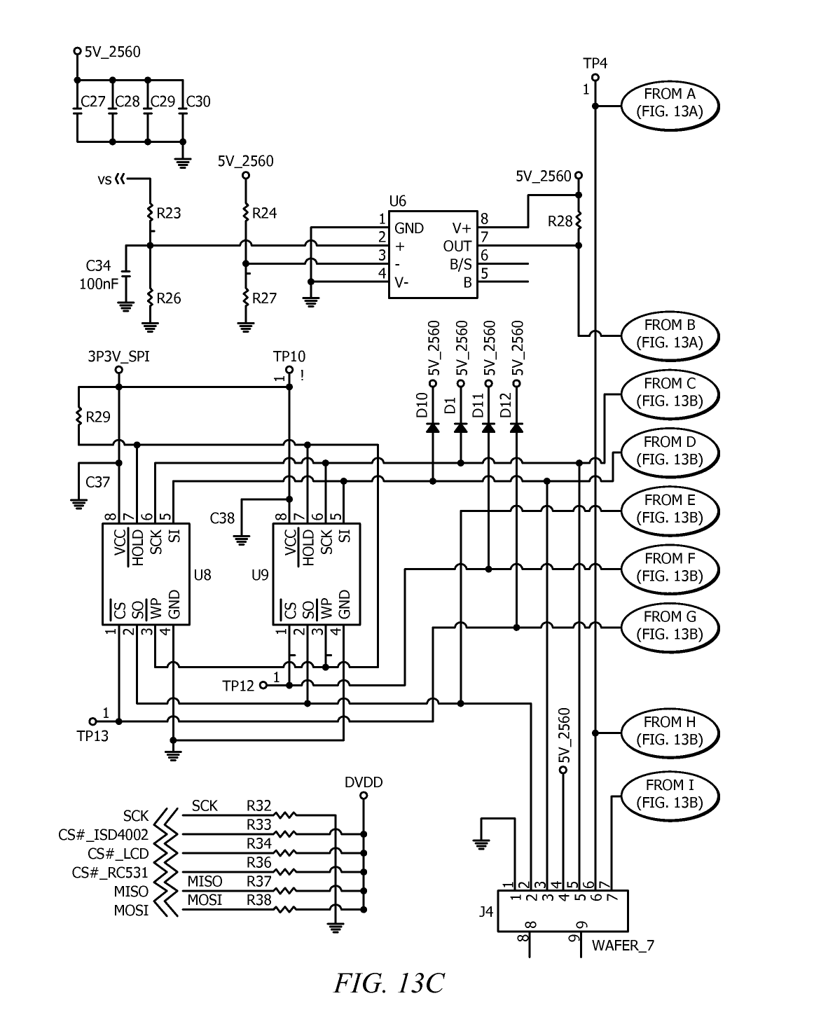

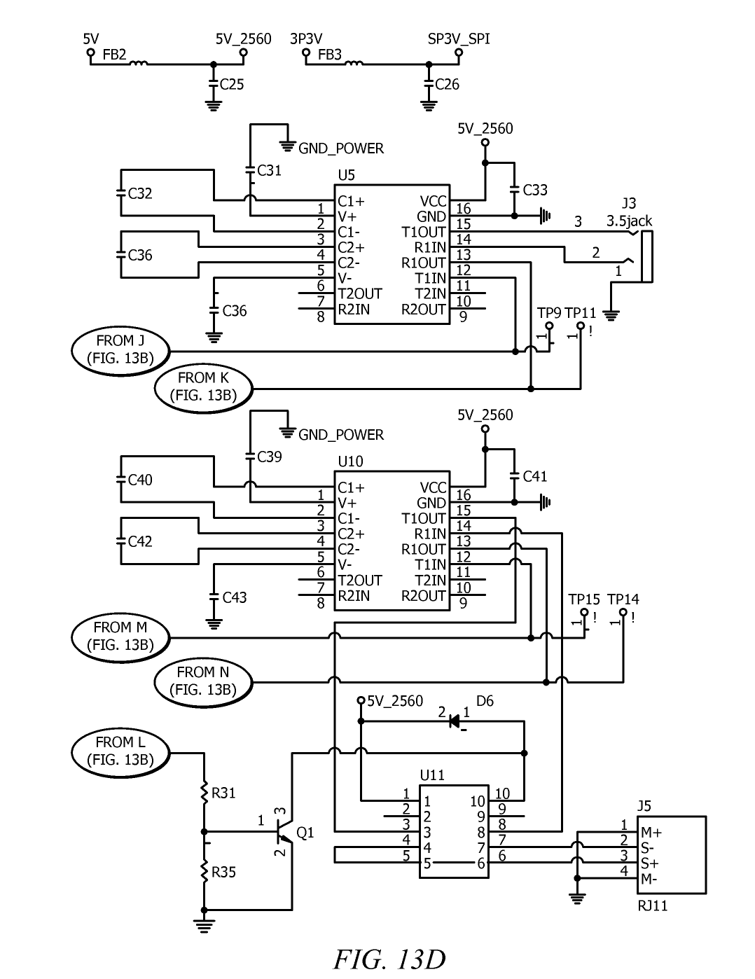

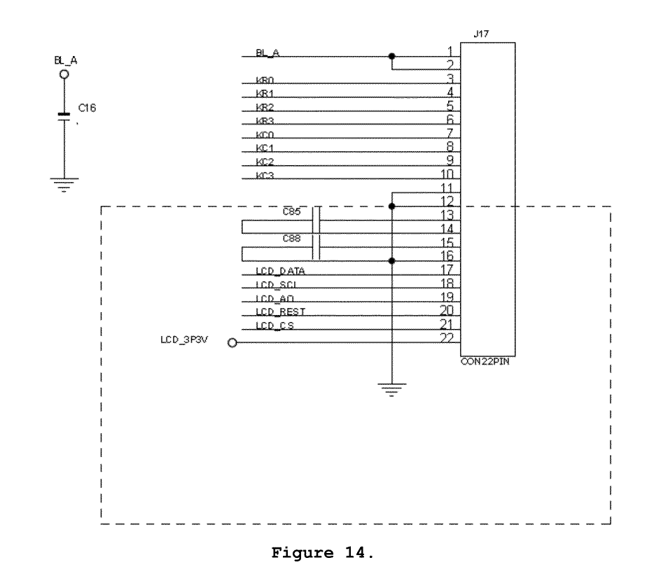

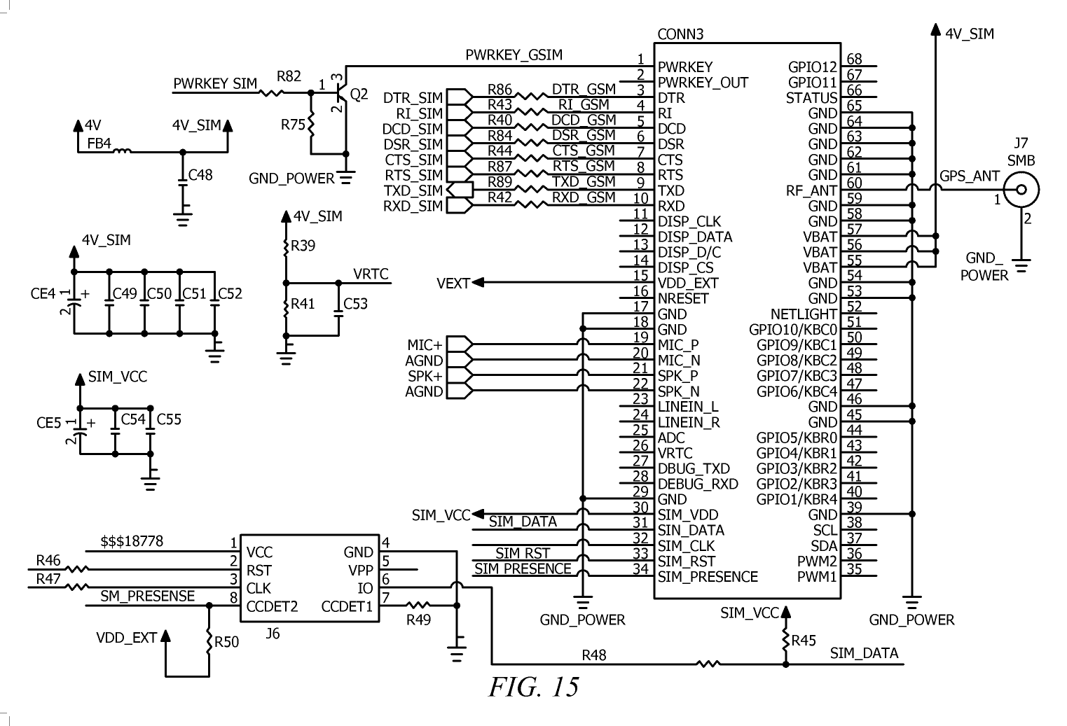

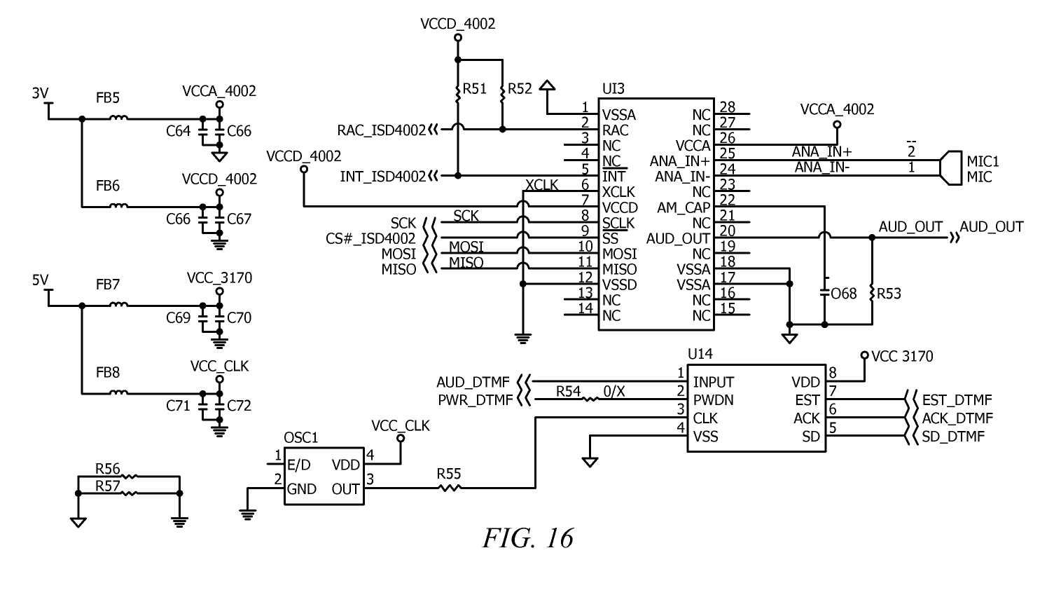

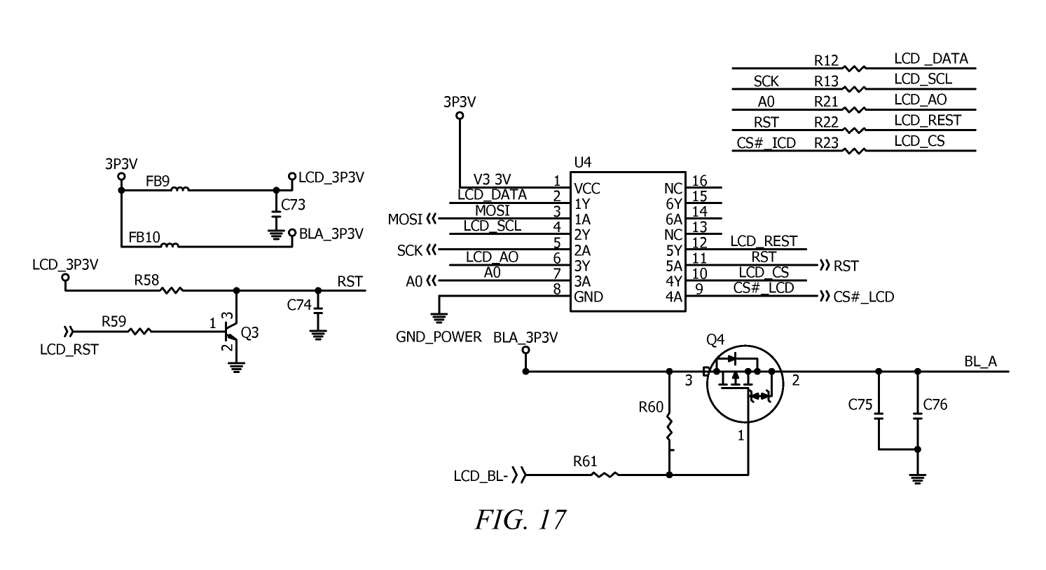

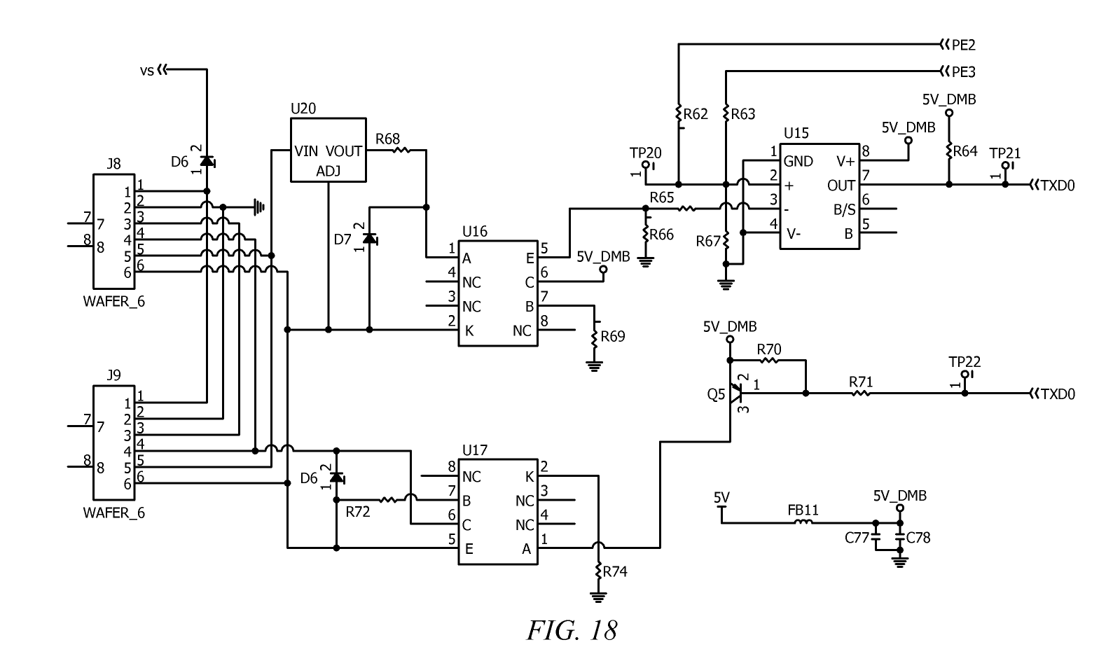

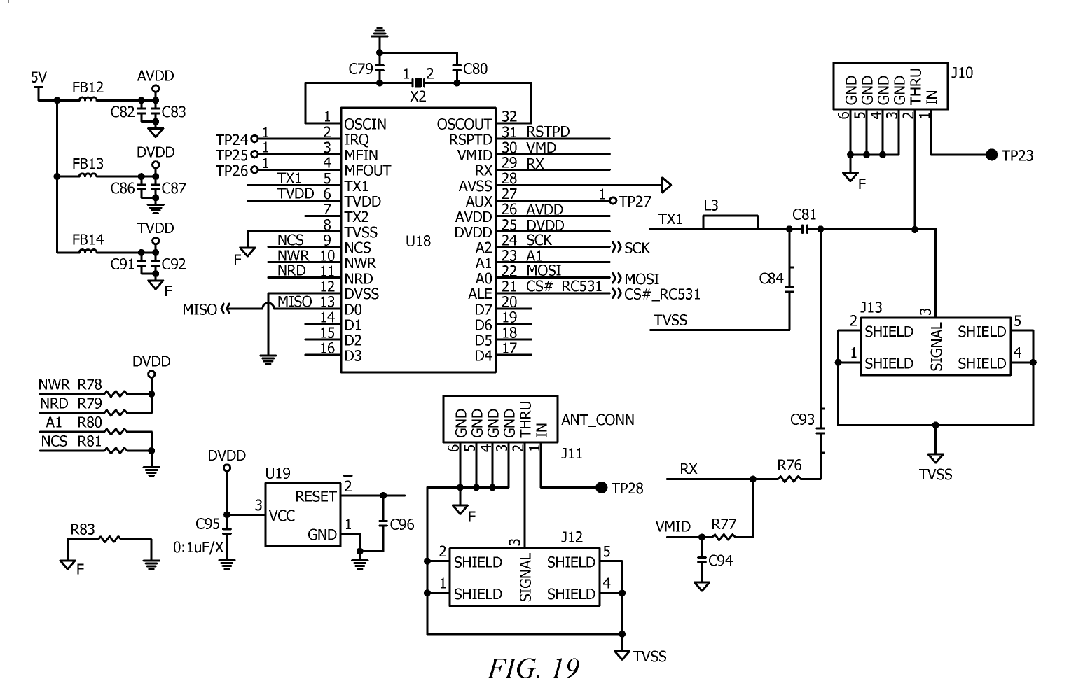

The Printed Circuit Board (PCB) that contains the telemetry module AE2.0 circuits is represented through a schematic diagram that is divided into 8 sections according to its functionality: 1. Feeding circuits (FIG. 12), 2. Circuit control and ports: DEX and debug (FIGS. 13A-D), 3. Matrix for keypad and LCD (FIG. 14), 4. Modem circuit (FIG. 15), 5. Voice circuit (FIG. 16), 6. LCD Circuit (FIG. 17, 7. MDB Circuit (FIG. 18), and 8. Radiofrequency cards circuit (FIG. 19).

1. Supply Circuits (FIG. 12)

This section contains 4 supply circuits, which have the function of regulating voltage received to a lesser level of tension to supply the different devices used in the card. The first circuit (U1) receives the entry standard level of tension MDB (known as VS), which varies between a minimum of 20V and a maximum of 42.5V with peaks of up to 45V. The exit voltage of this first regulating commuted circuit is of 5V with a maximum current of 3 A. The rest of the circuitry is passive: coils, capacitors, and resistances, which are necessary for its proper functioning.

The other 3 circuit regulators (U2, U3, and U21) use as an entry the 5V obtained with the U1 regulator chip, and deliver 3.3V, 3V, and VCC upon exit. Each of these tensions is used to supply different sections of the circuit.

2. Circuit Control and Ports: DEX and Debug (FIGS. 13A-D)

This section contains the “brain” of the telemetry module AE2.0. The control chip is an 8 bit microcontroller with RISC architecture (Reduced Instruction Set Computer). All of the devices contained in the electronic card work as peripherals of this chip. For the aforementioned chip to execute all of the telemetry functions, it requires a firmware stored in its internal flash memory.
In the electronic diagram of this section, some support chips for the microcontroller also appear. Two of these chips are flash memories that are used to store the content of the DEX extractions from the vending machines. Another 2 chips are level TTL-RS232 switches that are connected to 2 of the microcontroller's USART ports (USART1 and USART2). USART1 is used together with a reliever for communication with the vending machine using protocol DEX. On the other hand, USART2 is used as a “debug” port to connect a PC, laptop, etc., and interact with it to review or implement firmware functions.
Finally, a U6 analog comparator is implemented to measure the level of MDB voltage and compare it with the level of supply for the microcontroller. According to the results of comparison, PE2 and/or PE3 pins connected to another comparator in the MDB circuit are enabled or not. This proceeding is necessary, given that vending machine manufacturers do not use a standard value of supply. Some brands use a greater or lesser voltage than others and this might cause failures if not taken into consideration.

3. Matrix for the Keypad and LCD (FIG. 14)

The J17 connector is responsible for transporting the keypad signals and the LCD of the control cart to the corresponding card. KR0 to KR3 and KC0 to KC3 signals are responsible for making up the matrix that is the origin of the 16 keys of interface with the user. The remaining signals of this section of the diagram work as control for the liquid crystal LCD screen.

4. Modem Circuit (FIG. 15)

This section of the diagram illustrates the CONN3 circuit, which is a GSM/GPRS modem used as a means of communication for the system's telemetry functions. The Q2 transistor, along with its polarizing resistances, is manipulated by the microcontroller to shut down and turn on the modem whenever necessary. The SMB connector is used as the modem's antenna, and the J6 platform is for the insertion of the SIM Card with credit and data for cellular network connection

5. Voice Circuit (FIG. 16)

This section contains a circuit (U13) that has the functions of voice recording and/or playback. It may be used to store one or more high quality audio recordings, to be then locally or remotely played, similar to a traditional answering machine. Although it is an optional section of the system, it may contain useful information regarding the vending machine.
The other circuit within this section is U14, which has the function of decoding telephone codes (Dual Tone Multi Frequency or DTMF), converting them into binary digits and sending them to a microcontroller. This circuit is also optional, and allows for identification of a number dialed in the modem to be processed by the microcontroller.

6. Circuit for LCD (FIG. 17)

This section contains a manipulating chip for voltage levels that allows for the transfer of information from high levels to low levels. This is necessary because the microcontroller sends data to the LCD with levels of 0V and 5V, while the LCD only understands 0V and 3.3V data.

7. MDB Circuit (FIG. 18)

For MDB communication, a master and a slave port are required. According to the standard, peripheral devices of the control card in the vending machine are of the slave kind and must be isolated by its own optical means. For this reason, the card for module AE2.0 possesses 2 opto-couplers (U16 and U17), that enable such isolation to occur properly.

The U20 regulator placed in series with the receiving line of the AE2.0 module is used to adapt the levels of the data from the vending machine, when this data arrives altered to a certain degree due to any cause.

The U15 chip works along with the U16 opto-coupler as an isolator for digital transmission that allows for the separation of electric connections among both circuits, but without losing quality in signal transmission.

8. Circuit for Radio Frequency Cards (FIG. 19)

This part is optional, and it displays the connection diagram for the reading of contact-less smart cards, using technology based on the ISO14443 standard. The U18 chip is a member of a new family of reading circuits of high integration to 13.56 MHz. Furthermore, it supports all the layers of ISO14443, including the communication scheme of types A and B. On the right part of the diagram one can see the connection of the antenna's connector for this reader.
The circuit represented in FIGS. 12 to 19 herein may be used for other types of uses, such as payment in taxis by means of the same system that manages the vending machines (VMs), meaning that the remote monitoring will show in real time the earnings produced by the taxi. This same device may be further used for endless services where payment from a person is required, and so is its remote monitoring through the novelty algorithms, methods, and systems herein.
Even though this invention has been demonstrated and described with regards to specific modes, it is not limited to them. It will be evident for the reader that numerous adjustments, changes, and improvements may be made.

1. An adaptable system of telemetry and sale of intangible products for vending machines comprising:
at least one vending machine;
at least one telemetry module;
at least one control card in the vending machine;
a coin slot (optional);
a bill slot (optional);
a means of communication DEX;
a communication bus MDB;
means of wireless communication;
at least one database; and
peripherals.

2. The adaptable system of telemetry and sale of intangible products for vending machine of claim 1, wherein:
the control card that is incorporated into the vending machines (within the module) connected through DEX and MDB ports and that furthermore connects with various applications (web and desktop) designed for their administration and operation (jointly called Backoffice);
a monochromatic 128×64 pixels graphic liquid crystal screen with backlighting, that enables the display of texts in different fonts and sizes, images, and animations in 2D and 3D;
a 4×4 keypad with numerical characters and some extra keys such as: #, *, <, >, x, and Enter; and
the means of wireless communication includes a communication protocol used between the telemetry module and the computer system (Backoffice) that contains the management, operation, and database(s) applications.

3. The adaptable system of telemetry and sale of intangible products for vending machine of claim 1, further comprising:
a serial port for the microcontroller with the function of cleaning and monitoring the functions of the module.

4. The adaptable system of telemetry and sale of intangible products for vending machine of claim 1, wherein the telemetry module is comprised of:
a microcontroller;
an LCD screen;
a WiFi port;
an NFC port;
a Bluetooth port;
a slave MDB circuit;
an external power supply;
an MDB port;
a reliever;
a DEX port;
a Series RS-232 port;
a reader for cards with a chip;
a numerical keypad;
a magnetic stripe card reader;
a thermal printer;
an Ethernet port;
ADC channels;
a wireless modem;
a Flash memory 1; and
a Flash memory 2.

5. A method of implementing an adaptable system of telemetry and sale of intangible products for vending machines, the method comprising:
updating firmware;
initiating peripherals, all peripherals that form a part of the microcontroller such as DEX, MDB, SPI, among other ports, are initiated;
updating firmware, a new version of firmware is stored in the memory of the controller, which begins to operate immediately after the module has been restarted;
initiation of the operational system tasks, whether the tasks are used or not;
review that there exists a valid SIM card in the corresponding port;
configure connection parameters, these parameters correspond to the APN network to which the connection is intended;
connect to the APN, and ServerV;
verify connections
display a connection error number in a main screen, in case of error; and
display main menu.
